(19) United States
(12) Patent Application Publication
(10) Pub. No.: US 2006/0254840 A1
(43) Pub. Date: Nov. 16, 2006

(54) VEHICLE FOR TRAVELING OVER UNEVEN TERRAIN

(76) Inventor: Russell W. Strong, Craftsbury Common, VT (US)

Correspondence Address: ARTZ & ARTZ, P.C., 28333 TELEGRAPH RD., SUITE 250, SOUTHFIELD, MI, 48034, US

(21) Appl. No.: 11/383,528

(22) Filed: May 16, 2006

Related U.S. Application Data
(60) Provisional application No. 60/683,002, filed on May 16, 2005.

(51) Int. Cl. B62M 27/02; B62D 61/10; B60G 17/00; B62D 53/06

(52) U.S. Cl. 180/190; 180/22; 280/6.157; 280/149.2; 280/43

(57) ABSTRACT

A vehicle capable of traveling over uneven ground is disclosed herein. The vehicle includes a body, a frame, a pair of front wheels, an adjustable axle assembly, two pairs of rear wheels, and an actuation system. The body is mounted to the frame, and the frame has front and rear ends with a fore-aft axis extending therebetween. The front wheels are rotatably mounted opposite each other at the front end of the frame, and the adjustable axle assembly is mounted at the rear end of the frame substantially orthogonal to the fore-aft axis. The wheels in each of the two pairs of rear wheels are rotatably mounted opposite each other at the ends of the adjustable axle assembly. The actuation system is capable of mechanically moving the adjustable axle assembly to thereby adjust the fore-aft positions of the rear wheels relative to the frame.

### CROSS REFERENCE TO RELATED APPLICATION(S)

The present invention claims priority from U.S. Provisional Application Ser. No. 60/683,002, originally entitled “Moveable Oscillating Dual-Drive Wheels on a Zero-Turn Vehicle,” which was filed on May 16, 2005.

### FIELD OF THE INVENTION

The present invention generally relates to road vehicles, off-road vehicles, or all-terrain vehicles (ATVs) suitable for traveling over even or uneven terrain in various environments. The present invention more particularly relates to vehicles such as, for example, automotive vehicles, recreational vehicles, snowmobiles, agricultural vehicles, utility vehicles, construction vehicles, military vehicles, or robotic vehicles.

### BACKGROUND OF THE INVENTION

A “zero turn” (ZT) vehicle, as is commonly known in the art, will in some embodiments typically include, for example, a frame, a power source, a body, a primary axle assembly, two drive wheels, and two dolly wheel assemblies. The power source is commonly mounted to the central or rear portion of the frame and typically includes, for example, at least one engine or motor. The body, too, is mounted to the frame and is suitable for carrying a human load, for example, the vehicle operator, and an object load as well. The primary axle assembly is also mounted to the frame. In particular, the primary axle assembly is typically mounted to the rear portion of the frame such that the primary axle assembly is aligned substantially orthogonal to the length of the frame. The two drive wheels, in turn, are rotatably mounted on the ends of the primary axle assembly such that the drive wheels are aligned substantially in parallel and are in mechanical communication with the power source. To facilitate ease in vehicle movement and travel, the two dolly wheel assemblies, lastly, are typically mounted to the front portion of the frame. In such a configuration, the two drive wheels are capable of facilitating both driving and moving interaction with the ground. The two dolly wheel assemblies, however, merely cooperate with the two drive wheels in generally maintaining the overall balance of the vehicle as the vehicle travels over the ground.

As is uniquely characteristic of a ZT vehicle, the two drive wheels are particularly rotatably mounted to the primary axle assembly so that they each have independent drive capability. That is, both the speed and the direction of rotation of the two drive wheels are controlled independently from each other as dictated by the vehicle operator through the delivery of power from the power source. In this way, steering the vehicle in a desired direction of travel is successfully accomplished by the vehicle operator through independently varying, as necessary, the rotational speed and direction of each drive wheel. As a result, a ZT vehicle is much more highly maneuverable as compared to automotive vehicles incorporating more traditional linkage or rack-and-pinion front axle steering systems. In particular, a ZT vehicle is virtually capable of “turning on a dime” and therefore has an overall vehicle turning radius of zero. The two ground-interacting dolly wheels associated with the two dolly wheel assemblies are each swivel mounted to the frame and rotatable such that they both merely cooperate with the two drive wheels in maintaining the overall balance of the vehicle as the vehicle travels over the ground. Thus, the two ground-interacting dolly wheels themselves are, by design, not capable of being directly steered by the vehicle operator.

Although a ZT vehicle has the inherent advantage and desirable characteristic of having such zero turn capability, a ZT vehicle also has some inherent disadvantages and undesirable characteristics as well. For example, if, as opposed to traveling directly up or directly down the side of a hill, a ZT vehicle is instead traveling across the side of a hill, the front portion of the vehicle naturally tends to pull the front end of the vehicle sideways and downhill. Such a tendency is due in respective part to three reasons. First, the typical ZT vehicle, as described hereinabove, is commonly weighted at its front end in order to maintain vehicle stability when driving up steep inclines. Second, the typical ZT vehicle, as described hereinabove, includes two ground-interacting dolly wheels mounted to the front portion of the frame that provide no directional stability for the front end of the vehicle. Third, since the “uphill” drive wheel of the vehicle naturally has less traction than the “downhill” drive wheel of the vehicle due to the incline of the hill effectively shifting more of the vehicle weight to the downhill drive wheel, the uphill drive wheel is prone to losing traction and therefore slipping. When such slipping occurs, the directional stability normally provided by the uphill drive wheel is lost, thereby causing the front end of the vehicle to be gravitationally pulled sideways and downhill.

To help correct the problem associated with traveling across a hillside, engineers commonly prescribe designs for ZT vehicles wherein most of the overall weight of the vehicle is shifted further back along the length of the frame. In doing so, most of the vehicle weight is thereby particularly centered just in front of and over the primary axle assembly. As a result, improved traction of the two drive wheels mounted on the ends of the primary axle assembly is realized and less pull at the front end of the vehicle is also realized whenever the vehicle travels across a hillside. However, a problem sometimes arises when the ZT vehicle attempts to travel directly up a steep hill. In particular, if the incline of a hill is sufficiently severe, the front end of the ZT vehicle comes off the ground as the overall weight and center of gravity of the vehicle shifts rearward and beyond the points of contact between the two drive wheels and the ground. Furthermore, even if the incline of a hill is not so severe, a sudden burst of acceleration by the ZT vehicle as initiated by a vehicle operator while driving the vehicle also frequently causes the front end of the vehicle to come off the ground. In extreme cases of these two types of situations, the front end of the ZT vehicle sometimes comes off the ground to the extent that the vehicle is altogether upended.

In order to remedy the problem associated with traveling directly up a steep hill, most designs for ZT vehicles include either a “wheelie bar” (sometimes simply called a “roller bar”) or a skid plate. Such a wheelie bar or skid plate is mounted to the rear end of the vehicle frame to thereby prevent the vehicle from being altogether upended whenever the front end of the vehicle comes off the ground. The inclusion of one or both such remedial fixtures is reasonably effective in facilitating vehicle travel up a hill in cases where the front end of the vehicle infrequently and merely momentarily comes off the ground. However, such remedial fixtures have proven to be undesirable in cases where the front end of the vehicle comes off the ground for prolonged periods of time, for the fixtures in such cases give rise to drag that significantly inhibits rather than facilitates uphill travel.

To help eliminate the problems associated with traveling both across and up a hill, some engineers have designed ZT vehicles that include a manually adjustable ballast system. When used, such an adjustable ballast system has to, first of all, be manually preset. Once preset, the ballast system can then be effectively utilized onboard the vehicle, especially when traveling over long stretches of anticipated or known terrain with consistent topography or grade characteristics. However, such a manually adjustable ballast system has proven to be largely inconvenient to use when traveling over unanticipated or unknown terrain with extreme and everchanging topography or grade characteristics. Furthermore, such a manually adjustable ballast system has also proven to be largely inconvenient to use whenever frequent and significant changes in the human load and/or the object load onboard the vehicle are made.

In an attempt to correct the problem associated with traveling over extreme and everchanging terrain, engineers have designed ZT vehicles that include two elongated ground-interacting track assemblies. The two track assemblies are mounted to the frame of the vehicle such that the two drive wheels, or drives associated therewith, are engaged within the two track assemblies to thereby facilitate both driving and moving interaction of the two track assemblies with the ground. In such a configuration, dolly wheel assemblies are typically not included. Although such elongated track assemblies are effective in improving the overall fore-aft stability of the vehicle when traveling over extreme and everchanging terrain, the inherent elongated nature of the track assemblies undesirably limits, in some situations, the zero turn capability of the vehicle. In addition, given the typical variation in fore-aft (i.e., front-to-back) loading of a ZT vehicle, each elongated track assembly often fails to properly interact with the ground in an even pressure-distributed manner along its respective length, thereby undesirably negating a characteristic advantage of utilizing such elongated track assemblies on terrain with, for example, sand or snow.

To remedy the problem associated with designing a ZT vehicle that successfully travels over extreme and everchanging terrain without limiting the zero turn capability of the vehicle, some engineers have designed a ZT vehicle that includes a gyroscopic sensor system. In particular, the vehicle includes a system of multiple gyroscopic sensors electrically connected to one or more electronic controllers. The electronic controllers, in turn, are electrically connected to drive wheel motors which themselves are in mechanical communication with the two drive wheels. In such a configuration, the gyroscopic sensors continuously sense the attitude or balance condition of the vehicle as the vehicle travels over everchanging terrain. While doing so, the gyroscopic sensors also continuously communicate electrical vehicle attitude or balance condition information signals to the electronic controllers. The electronic controllers, in turn, then process the electrical vehicle attitude information signals, generate electrical control signals based on the vehicle attitude information, and communicate the electrical control signals to the drive wheel motors. The drive wheel motors then mechanically operate the two drive wheels in compliance with the electrical control signals received from the electronic controllers. In this manner, the gyroscopic sensor system attempts to continuously maintain the fore-aft stability and overall balance of the vehicle by regulating the fore-aft driving rotation of the two drive wheels underneath the vehicle such that the overall weight and/or load of the vehicle is generally centered and maintained over the primary axle assembly and drive wheels. Although such a ZT vehicle with gyroscopic sensor system is reasonably effective in maintaining vehicle balance under most conditions, such is only marginally effective under conditions of reduced traction. For example, if an area of ground on a hillside is significantly covered with sand, loose gravel, mud, water, snow, or ice, a ZT vehicle with gyroscopic sensor system sometimes has difficulty in maintaining its balance while traveling thereon. Such difficulty is due to the fact that good traction necessary for drive wheel movement to quickly correct any vehicle imbalance is not always available under such reduced traction conditions.

In light of the above, there is a present need in the art for a vehicle and/or a vehicle system that (1) successfully maintains vehicle balance when traveling directly up a hill, (2) successfully maintains vehicle balance when traveling across a hillside, (3) successfully maintains vehicle balance even when a vehicle operator attempts rapid acceleration or sudden braking, (4) successfully maintains vehicle balance when traveling over terrain with extreme and everchanging topographies, (5) successfully maintains vehicle balance and optimizes traction even when there are significant and frequent changes in human load and/or object load onboard the vehicle, (6) successfully maintains vehicle balance even under reduced traction conditions, (7) does not unnecessarily limit maximum zero turn capability in a ZT vehicle, and (8) is successfully applicable to both ZT vehicles and non-ZT vehicles as well.

### SUMMARY OF THE INVENTION

The present invention provides a vehicle capable of traveling over uneven ground or terrain. In one practicable embodiment, the vehicle includes a body, a frame, a pair of front wheels, an adjustable axle assembly, two pairs of rear wheels, and an actuation system. The body is mounted to the frame, and the frame has front and rear ends with a fore-aft axis extending therebetween. The front wheels are rotatably mounted opposite each other at the front end of the frame, and the adjustable axle assembly is mounted at the rear end of the frame substantially orthogonal to the fore-aft axis. The wheels in each of the two pairs of rear wheels are rotatably mounted opposite each other at the ends of the adjustable axle assembly. The actuation system is capable of mechanically moving the adjustable axle assembly to thereby adjust the fore-aft positions of the rear wheels relative to the frame. In this same or other embodiment, the vehicle may further include a second actuation system. The second actuation system is capable of mechanically rotating the adjustable axle assembly to thereby adjust the heights of the rear wheels relative to the frame.

In still another practicable embodiment, the vehicle may include a body, a frame, at least one ski, an adjustable axle assembly, a pair of drive track assemblies, a first actuation system, and a second actuation system. The body is mounted to the frame, and the frame has front and rear ends with a fore-aft axis extending therebetween. Each ski is mounted at the front end of the frame, and the adjustable axle assembly is mounted at the rear end of the frame substantially orthogonal to the fore-aft axis. The drive track assemblies are mounted opposite each other at the ends of the adjustable axle assembly. The first actuation system is capable of mechanically moving the adjustable axle assembly to thereby adjust the fore-aft position of the drive track assemblies relative to the frame. The second actuation system is capable of mechanically rotating the adjustable axle assembly to thereby adjust the pitch of the drive track assemblies relative to the frame.

Furthermore, it is believed that still other embodiments of the present invention will become apparent to those skilled in the art when the detailed descriptions of the best modes contemplated for practicing the invention, as set forth hereinbelow, are reviewed in conjunction with the appended claims and the accompanying drawing figures.

### BRIEF DESCRIPTION OF THE DRAWINGS

The present invention is described hereinbelow, by way of example, with reference to the following drawing figures.

FIG. 1A is a rear perspective view of a first embodiment of the vehicle according to the present invention, wherein the vehicle includes a telescoping cylinder actuation system engaged with an adjustable swing arm axle assembly such that the two rear drive wheels of the vehicle are in a fully retracted (forward) fore-aft position.

FIG. 1B is a rear perspective view of the vehicle depicted in FIG. 1A, wherein the telescoping cylinder actuation system is alternatively engaged with the adjustable swing arm axle assembly such that the two rear drive wheels of the vehicle are in a fully extended (rearward) fore-aft position.

FIG. 2A is a rear perspective view of the vehicle depicted in FIG. 1A, wherein the frame of the vehicle is particularly highlighted and the telescoping cylinder actuation system is engaged with the adjustable swing arm axle assembly such that the two rear drive wheels of the vehicle are in a fully retracted (forward) fore-aft position.

FIG. 2B is a rear perspective view of the vehicle depicted in FIG. 2A, wherein the frame of the vehicle is particularly highlighted and the telescoping cylinder actuation system is alternatively engaged with the adjustable swing arm axle assembly such that the two rear drive wheels of the vehicle are in a fully extended (rearward) fore-aft position.

FIG. 3 is a top view of the vehicle depicted in FIG. 2A, wherein the frame of the vehicle is particularly highlighted and the telescoping cylinder actuation system is engaged with the adjustable swing arm axle assembly such that the two rear drive wheels of the vehicle are in a fully retracted (forward) fore-aft position.

FIG. 4 is a block diagram illustrating how electrical information signals are communicated to an electronic controller onboard the vehicle and how electrical control signals are communicated from the electronic controller to the actuation system.

FIG. 5 is a rear view of the vehicle depicted in FIGS. 2A and 3, wherein the frame of the vehicle is particularly highlighted and the telescoping cylinder actuation system is engaged with the adjustable swing arm axle assembly such that the two rear drive wheels of the vehicle are in a fully retracted (forward) fore-aft position.

FIG. 6A is a partial cut-away side view of the vehicle depicted in FIGS. 2A, 3, and 5, wherein the frame of the vehicle is particularly highlighted and the telescoping cylinder actuation system is engaged with the adjustable swing arm axle assembly such that the two rear drive wheels of the vehicle are in a fully retracted (forward) fore-aft position.

FIG. 6B is a partial cut-away side view of the vehicle depicted in FIG. 6A, wherein the frame of the vehicle is particularly highlighted and the telescoping cylinder actuation system is alternatively engaged with the adjustable swing arm axle assembly such that the two rear drive wheels of the vehicle are in a fully extended (rearward) fore-aft position.

FIG. 7A is a cut-away side view of a telescoping cylinder actuation system engaged with an adjustable swing arm axle assembly included in an alternative embodiment of the vehicle according to the present invention, wherein the two rear drive wheels of the vehicle are in a fully retracted (forward) fore-aft position.

FIG. 7B is a cut-away side view of the telescoping cylinder actuation system engaged with the adjustable swing arm axle assembly depicted in FIG. 7A, wherein the two rear drive wheels of the vehicle are alternatively in a fully extended (rearward) fore-aft position.

FIG. 8A is a cut-away side view of a telescoping cylinder actuation system engaged with an adjustable slide arm axle assembly included in another alternative embodiment of the vehicle according to the present invention, wherein the two rear drive wheels of the vehicle are in a fully retracted (forward) fore-aft position.

FIG. 8B is a cut-away side view of the telescoping cylinder actuation system engaged with the adjustable slide arm axle assembly depicted in FIG. 8A, wherein the two rear drive wheels of the vehicle are alternatively in a fully extended (rearward) fore-aft position.

FIG. 9A is a cut-away side view of a rack-and-pinion actuation system engaged with an adjustable swing arm axle assembly included in still another alternative embodiment of the vehicle according to the present invention, wherein the two rear drive wheels of the vehicle are in a fully retracted (forward) fore-aft position.

FIG. 9B is a cut-away side view of the rack-and-pinion actuation system engaged with the adjustable swing arm axle assembly depicted in FIG. 9A, wherein the two rear drive wheels of the vehicle are alternatively in a fully extended (rearward) fore-aft position.

FIG. 10 is a rear sectional view of the rack-and-pinion actuation system along with a cross arm assembly of the adjustable swing arm axle assembly depicted in FIGS. 9A and 9B.

FIG. 11 is a side view of a second embodiment of the vehicle according to the present invention, wherein the vehicle is specifically implemented with two pairs of ground-interacting wheels suitable for traveling over uneven terrain.

FIG. 12 is a side view of a third embodiment of the vehicle according to the present invention, wherein the vehicle is specifically implemented with a single a pair of ground-interacting track assemblies suitable for traveling over uneven terrain.

FIG. 13 is a rear perspective view of a fourth embodiment of the vehicle according to the present invention, wherein the vehicle includes a telescoping cylinder actuation system engaged with an adjustable swing arm axle assembly such that two pairs of rear drive wheels of the vehicle are in a fully retracted (forward) fore-aft position.

FIG. 14 is a top view of the vehicle depicted in FIG. 13, wherein the frame of the vehicle is particularly highlighted and the telescoping cylinder actuation system is engaged with the adjustable swing arm axle assembly such that the two pairs of rear drive wheels of the vehicle are in a fully retracted (forward) fore-aft position.

FIG. 15 is a block diagram illustrating how electrical information signals are communicated to the electronic controller(s) onboard the vehicle of FIG. 13 and how electrical control signals are communicated from the electronic controller(s) to the actuation system(s).

FIG. 16 is a rear view of the vehicle depicted in FIGS. 13 and 14, wherein the frame of the vehicle is particularly highlighted and the telescoping cylinder actuation system is engaged with the adjustable swing arm axle assembly such that the two pairs of rear drive wheels of the vehicle are in a fully retracted (forward) fore-aft position.

FIG. 17A is a partial cut-away side view of the vehicle depicted in FIGS. 13, 14, and 16, wherein the frame of the vehicle is particularly highlighted and the telescoping cylinder actuation system is engaged with the adjustable swing arm axle assembly such that the two pairs of rear drive wheels of the vehicle are in a fully retracted (forward) fore-aft position.

FIG. 17B is a partial cut-away side view of the vehicle depicted in FIG. 17A, wherein the frame of the vehicle is particularly highlighted and the telescoping cylinder actuation system is alternatively engaged with the adjustable swing arm axle assembly such that the two pairs of rear drive wheels of the vehicle are in a fully extended (rearward) fore-aft position.

FIG. 17C is a partial cut-away side view of the vehicle depicted in FIG. 17A, wherein the frame of the vehicle is particularly highlighted and the telescoping cylinder actuation system is engaged with the adjustable swing arm axle assembly such that the two pairs of rear drive wheels of the vehicle are in a fully retracted (forward) fore-aft position, and also wherein the rotational actuation system has rotated the adjustable axle assembly such that the pair of front wheels is lifted off the ground.

FIG. 17D is a partial cut-away side view of the vehicle depicted in FIG. 17B, wherein the frame of the vehicle is particularly highlighted and the telescoping cylinder actuation system is alternatively engaged with the adjustable swing arm axle assembly such that the two pairs of rear drive wheels of the vehicle are in a fully extended (rearward) fore-aft position, and also wherein the rotational actuation system has rotated the adjustable axle assembly such that the first pair of rear wheels is lifted off the ground.

### LIST OF PARTS AND FEATURES

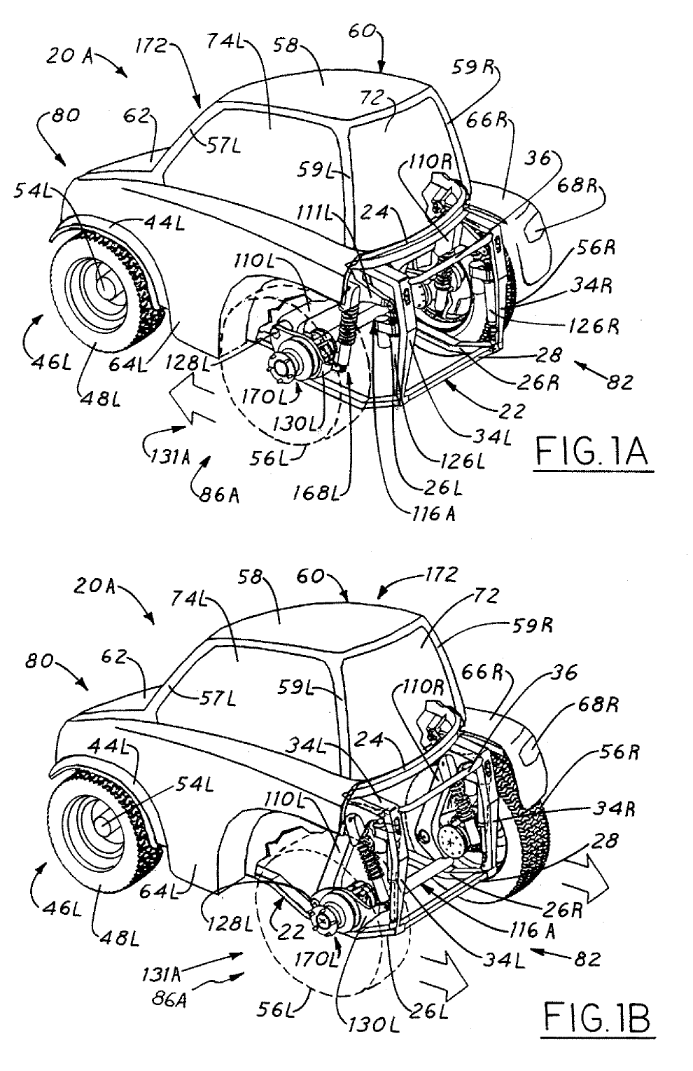

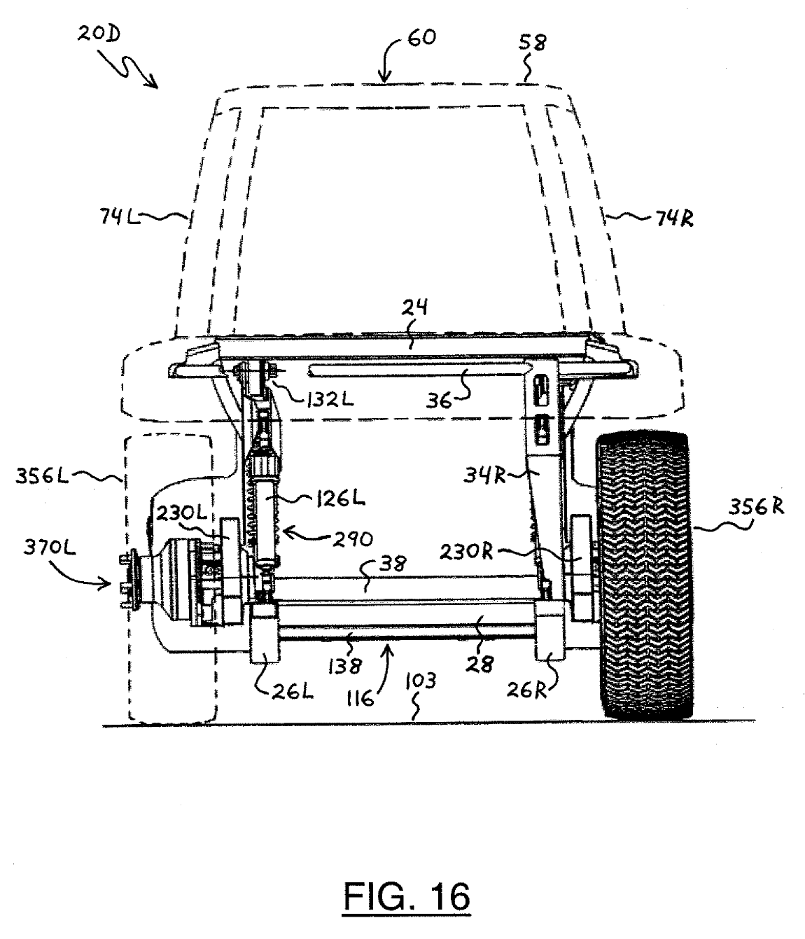

To facilitate a proper understanding of the present invention, a list of parts and features highlighted with alphanumeric designations in FIGS. 1 through 17D is set forth hereinbelow.
20 vehicle
20A vehicle (first embodiment)
20B vehicle (second embodiment)
20C vehicle (third embodiment)
20D vehicle (fourth embodiment)
22 elongate frame
24 support member
26L left support member
26R right support member
28 support member
30L left support member
30R right support member
32L left support member
32R right support member
34L left support member
34R right support member
36 support member
38 support member
40L left support panel
40R right support panel
42 support panel
44L left front fender
44R right front fender
46L left dolly (or caster) wheel assembly
46R right dolly (or caster) wheel assembly
56L left rear drive wheel
56R right rear drive wheel
57L left front support member (of roof panel)
57R right front support member (of roof panel)
59L left rear support member (of roof panel)
59R right rear support member (of roof panel)
58 roof panel
60 body
62 front hood panel
66L left rear fender
66R right rear fender
70 front window
72 rear window
74L left side window
74R right side window
76 rear panel
80 front end (of frame)
82 rear end (of frame)
84 fore-aft axis
86 adjustable axle assembly
88 adjustable axle assembly axis
90 actuation system (for fore-aft movement of the axle assembly)
96 electronic controller
98 operator control panel
102L left attitude sensor (for example, a gyroscope)
102R right attitude sensor
103 ground
106B total load sensor
106L left load sensor
106R right load sensor
108L left fore-aft position sensor (of adjustable axle assembly)
108R right fore-aft position sensor (of adjustable axle assembly)
110L left swing arm
110R right swing arm
116 cross arm assembly
126L left telescoping cylinder (fore-aft actuator)
126R right telescoping cylinder (fore-aft actuator)
128L pivot point (of left short suspension arm)
128R pivot point (of right short suspension arm)
130L left short suspension arm (of adjustable axle assembly)
130R right short suspension arm (of adjustable axle assembly)
131 actively adjustable axle system
132L pivot point (of left swing arm)
132R pivot point (of right swing arm)
134L left attachment point (of cross arm)
134R right attachment point (of cross arm)
138 cross arm
164L coil spring (of left strut assembly)
164R coil spring (of right strut assembly)
166L shock absorber (of left strut assembly)
166R shock absorber (or right strut assembly)
168L left strut assembly
168R right strut assembly
208 rotational position sensor (of adjustable axle assembly)
226L left rotary actuator (of second actuation system)
226R right rotary actuator (of second actuation system)
230L left long suspension arm (of adjustable axle assembly)
230R right long suspension arm (of adjustable axle assembly)
248L left front wheel (steerable)
248R right front wheel (steerable)
256L left wheel (of first pair of rear drive wheels)
256R right wheel (of first pair of rear drive wheels)
270L left hub-and-bearing assembly
270R right hub-and-bearing assembly
286 adjustable axle assembly
288 adjustable axle assembly axis (i.e., axis of rotation)
290 first actuation system (for fore-aft movement of the axle assembly)
296 electronic controller(s)
356L left wheel (of second pair of rear drive wheels)
356R right wheel (of second pair of rear drive wheels)
370L left hub-and-bearing assembly
370R right hub-and-bearing assembly
390 second actuation system (for rotation of the axle assembly)

### DETAILED DESCRIPTION OF THE INVENTION

As illustrated in FIGS. 1A through 12, the present invention generally provides a vehicle 20 with an actively adjustable axle system 131 situated onboard. The vehicle 20 is suitable for traveling over even or uneven terrain with a load. The actively adjustable axle system 131 itself generally includes an adjustable axle assembly 86, an actuation system 90, and an electronic controller 96. The electronic controller 96 is capable of communicating electrical control signals to the actuation system 90. The actuation system 90, in turn, is capable of mechanically adjusting the adjustable axle assembly 86 to thereby adjust the fore-aft position of any pair of wheels rotatably mounted on the ends of the adjustable axle assembly 86. In sum, therefore, the electronic controller 96 is capable of communicating electrical control signals to the actuation system 90 to thereby adjust the fore-aft position of the pair of wheels as necessary to actively maintain the overall balance, and particularly the fore-aft stability, of the vehicle 20 as the vehicle 20 travels over various types of terrain, especially uneven terrain. In general, such a vehicle 20 according to the present invention may be adapted or suited for use as, for example, an automotive vehicle, a recreational vehicle, an agricultural vehicle, a utility vehicle, a construction vehicle, a military vehicle, or a robotic vehicle. Detailed descriptions of preferred embodiments of the vehicle 20 according to the present invention are set forth hereinbelow wherein both the structures and operations of the preferred embodiments are discussed.

### 1. First Embodiment

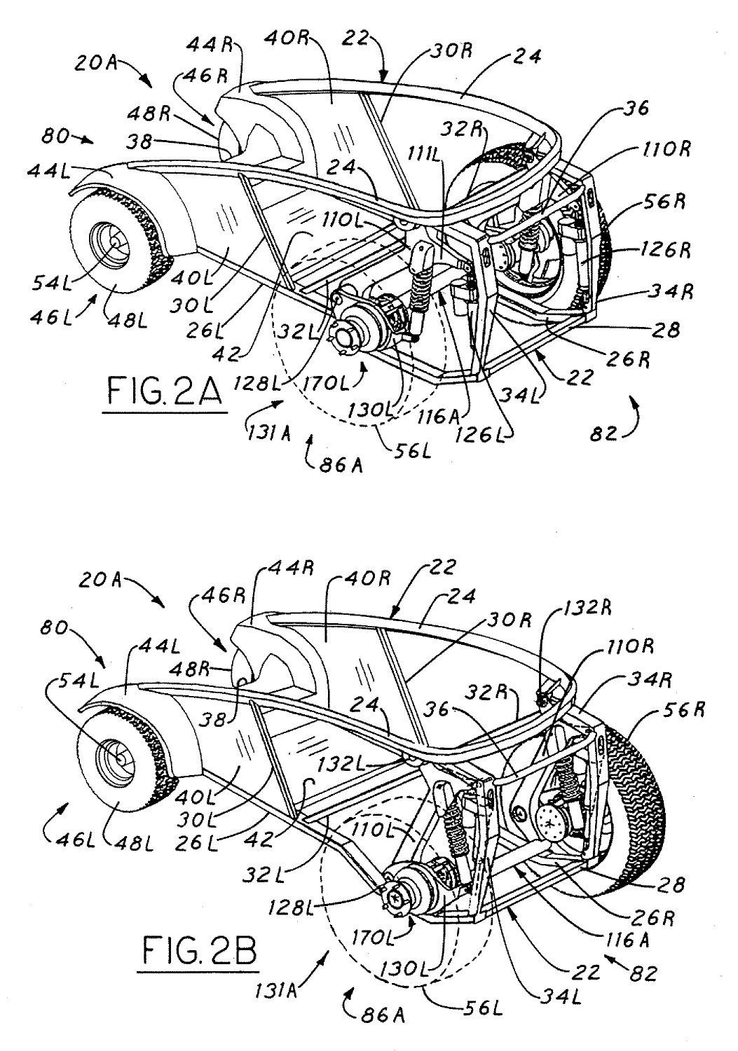

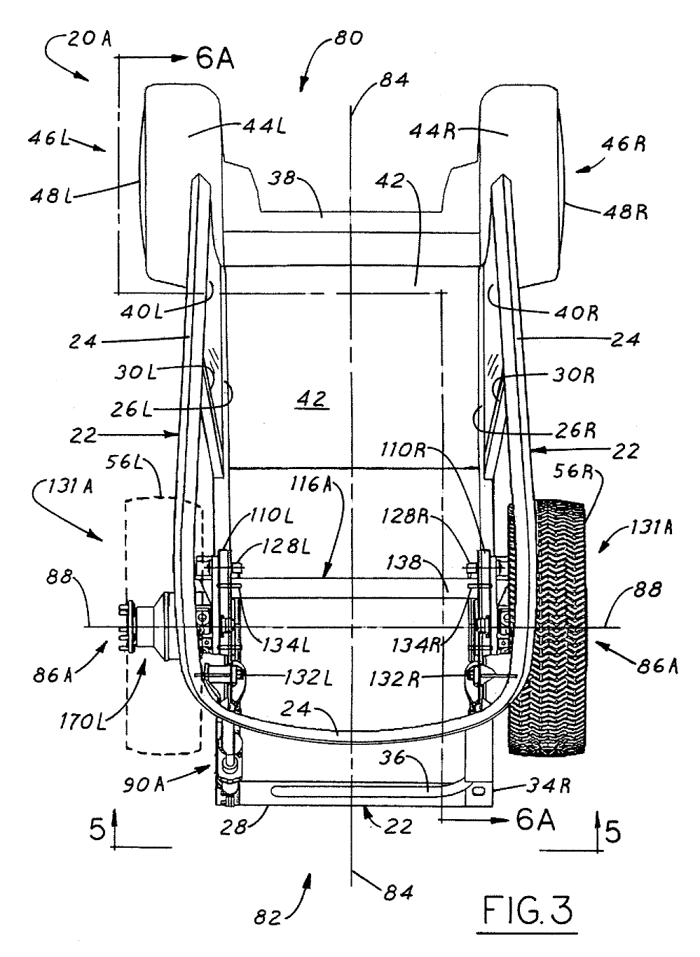

FIGS. 1A through 6B illustrate a first embodiment 20A of the vehicle 20 according to the present invention. The vehicle 20A is a zero turn (ZT) vehicle that includes, as particularly illustrated in FIG. 3, a frame 22 having an associated front end 80, a rear end 82, and a fore-aft axis 84 extending therebetween. The frame 22 itself includes a plurality of support members 24, 26L, 26R, 28, 30L, 30R, 32L, 32R, 34L, 34R, 36, and 38 and also a plurality of support panels 40L, 40R, and 42 assembled together as particularly illustrated in FIGS. 2A, 2B, 3, 5, 6A, and 6B. It is to be understood, however, that such support members and support panels may alternatively be formed as an integral whole. In addition to the frame 22, the vehicle 20A also includes a body 60 that is mounted to the frame 22. The body 60 itself optionally includes a roof panel 58, left and right front roof panel support members 57L and 57R, left and right rear roof panel support members 59L and 59R, a front hood panel 62, left and right side panels 64L and 64R, a rear panel 76, left and right front fenders 44L and 44R, and left and right rear fenders 66L and 66R assembled together as particularly illustrated in FIGS. 1A and 1B. Given such an assemblage of parts, a front window 70, left and right side windows 74L and 74R, a rear window 72, left and right head lights (not shown), and left and right tail lights 68L and 68R are successfully accommodated and incorporated within the vehicle 20A as well. Notwithstanding such a first embodiment 20A wherein the frame 22 and the body 60 are constructed separately before being mounted together, it is to be understood that the body 60 and the frame 22 may alternatively be constructed such that they are substantially integral with each other within a substantially “unitized” or “unibody” construction.

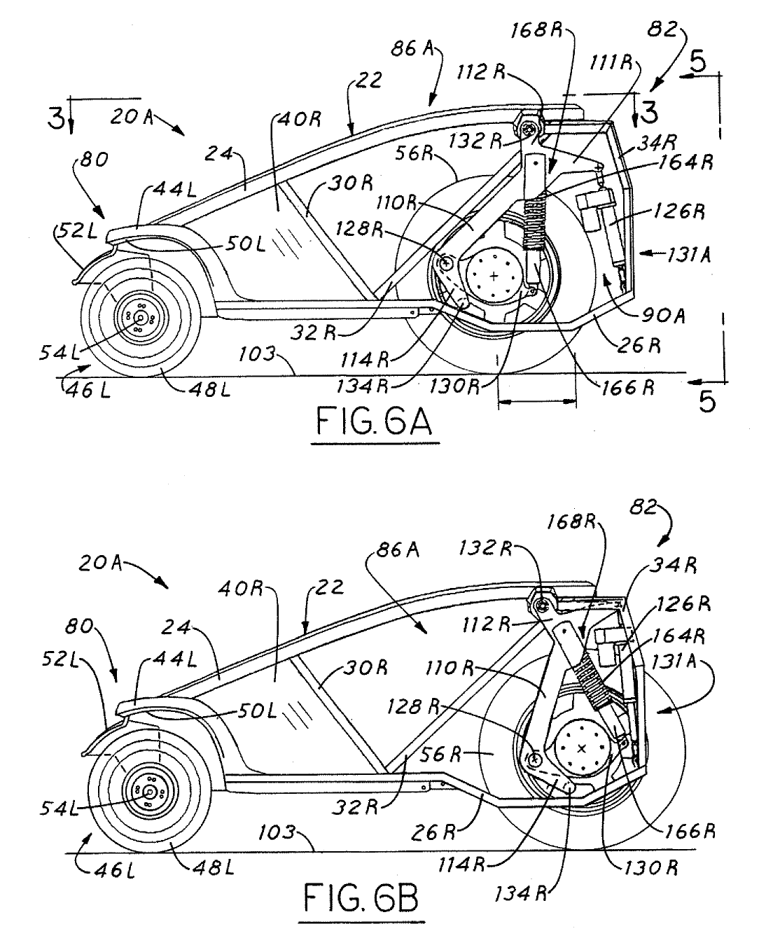

In addition to both the frame 22 and the body 60, the vehicle 20A also includes a first embodiment 131A of the actively adjustable axle system 131 with a pair of rear drive wheels 56L and 56R. The actively adjustable axle system 131A itself includes a first embodiment 86A of the adjustable axle assembly 86, a first embodiment 90A of the actuation system 90, and the electronic controller 96. The adjustable axle assembly 86A, as particularly illustrated in FIG. 3, is mounted to the rear portion of the frame 22 such that an adjustable axle assembly axis 88 associated with the adjustable axle assembly 86A is aligned substantially orthogonal to the fore-aft axis 84 associated with the frame 22. The adjustable axle assembly 86A itself includes a first embodiment 116A of a cross arm assembly 116 and also a pair of swing arms 110L and 110R. The cross arm assembly 116A, first of all, includes a single cross arm 138. As particularly illustrated in FIGS. 6A and 6B, the swing arms 110L and 110R, in turn, have pivotal ends 112L and 112R pivotally mounted at pivot points 132L and 132R to the frame 22 of the vehicle 20A. In addition, the swing arms 110L and 110R also have distal ends 114L and 114R interconnected with the cross arm 138 at attachment points 134L and 134R.

Given the adjustable axle assembly 86A as configured, the two rear drive wheels 56L and 56R are rotatably suspended from the two swing arms 110L and 110R proximate the distal ends 114L and 114R thereof. As particularly illustrated in FIGS. 1A, 1B, 2A, 2B, 6A, and 6B, suspension of the pair of rear drive wheels 56L and 56R from the pair of swing arms 110L and 110R is particularly achieved with both a pair of short suspension arms 130L and 130R and also a pair of strut assemblies 168L and 168R. The suspension arms 130L and 130R themselves have, first of all, first ends pivotally fastened at pivot points 128L and 128R to the swing arms 110L and 110R proximate the distal ends 114L and 114R thereof. In addition, the suspension arms 130L and 130R also have second ends indirectly connected to the swings arms 110L and 110R proximate the pivotal ends 112L and 112R thereof via the strut assemblies 168L and 168R. The two strut assemblies 168L and 168R themselves, in turn, include both coil springs 164L and 164R and also shock absorbers (or dampers) 166L and 166R. Given such a suspension configuration, the two rear drive wheels 56L and 56R themselves are particularly rotatably mounted to the middle sections of the two suspension arms 130L and 130R by means of a pair of hub-and-bearing assemblies 170L and 170R as particularly illustrated in FIGS. 1A through 3 and 5 through 6B. In this way, the two rear drive wheels 56L and 56R are thereby ultimately rotatably mounted on the ends of the adjustable axle assembly 86A such that the two rear drive wheels 56L and 56R are aligned substantially in parallel and are in mechanical, hydraulic, and/or electrical communication with a power source (not shown) mounted to the frame 22. The power source itself may include, for example, at least one engine or motor. As a result of being in such communication with the power source, the two rear drive wheels 56L and 56R of the vehicle 20A are thereby capable of facilitating both moving and independent driving interaction with the ground 103.

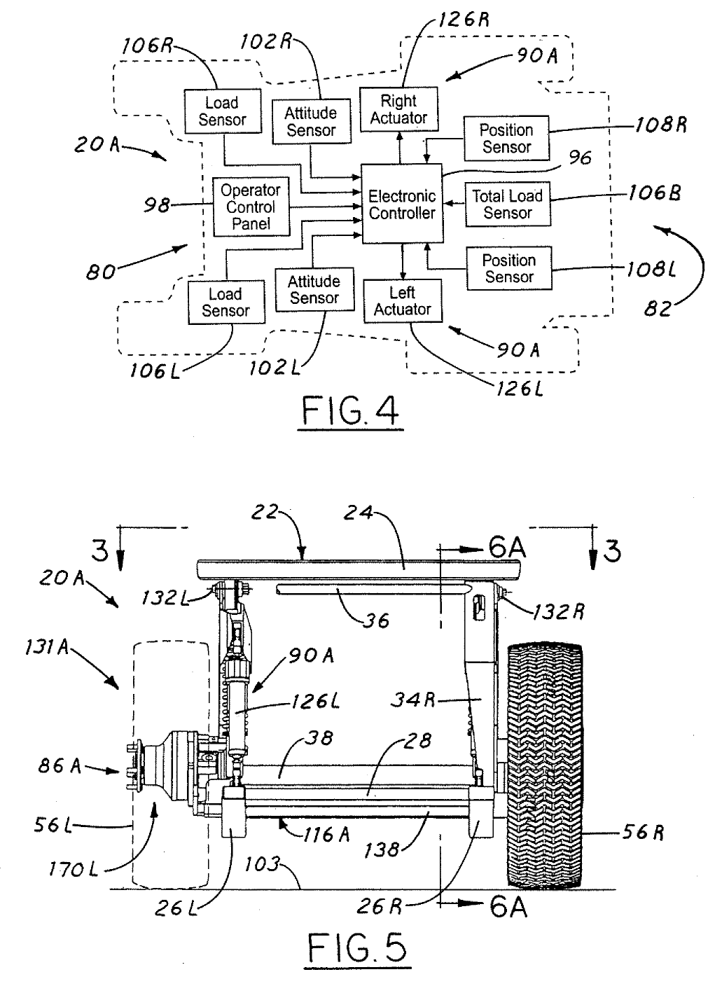

To facilitate adjustment of the adjustable axle assembly 86A, the actuation system 90A includes a pair of telescoping cylinders 126L and 126R serving as left and right actuators. As particularly illustrated in FIGS. 6A and 6B, the two telescoping cylinders 126L and 126R are preferably connected between the frame 22 of the vehicle 20A and projections 111L and 111R integral with the pivotal ends 112L and 112R of the two swing arms 110L and 110R. In addition, as particularly illustrated in FIG. 4, the two telescoping cylinders 126L and 126R are also electrically connected to the electronic controller 96 which itself is mounted to and/or within the body 60. In such a configuration, the electronic controller 96 is particularly capable of communicating electrical control signals to the two telescoping cylinders 126L and 126R to thereby adjust the fore-aft position of the pair of rear drive wheels 56L and 56R as necessary to actively maintain the fore-aft stability of the vehicle 20A.

In addition to the frame 22, the body 60, the actively adjustable axle system 131A, and the two rear drive wheels 56L and 56R, the vehicle 20A further includes a pair of dolly (or caster) wheel assemblies 46L and 46R. The dolly wheel assemblies 46L and 46R are mounted to the front portion of the frame 22 such that they cooperate with the two rear drive wheels 56L and 56R in generally maintaining the overall balance of the vehicle 20A as the vehicle 20A travels over the ground 103. As particularly illustrated in FIGS. 2A, 2B, 3, 6A, and 6B, the pair of dolly wheel assemblies 46L and 46R itself includes a pair of ground-interacting dolly wheels 48L and 48R, a matching pair of spindles 54L and 54R, a matching pair of swivel arms 52L and 52R, and a matching pair of swivel joints 50L and 50R. The two dolly wheels 48L and 48R are rotatably mounted on the two spindles 54L and 54R. The two spindles 54L and 54R, in turn, are connected to the two swivel arms 52L and 52R. The two swivel arms 52L and 52R are swivel mounted to the frame 22 by the two swivel joints 50L and 50R situated underneath the two front fenders 44L and 44R. Given such a configuration, the two dolly wheel assemblies 46L and 46R thereby serve as two supplemental ground-interacting apparatuses which cooperate with the two rear drive wheels 56L and 56R to thereby maintain clearance between both the frame 22 and the body 60 and the ground 103. The two ground-interacting dolly wheels 48L and 48R are, by design in this particular embodiment, not capable of being directly steered by a vehicle operator onboard the vehicle 20A. It is to be understood, however, that the two dolly wheels 48L and 48R may optionally be equipped to power rotate in sync or in coordination with the moving speed of the two rear drive wheels 56L and 56R.

As illustrated in FIG. 4, the vehicle 20A also includes an operator control panel 98 situated onboard. The operator control panel 98 is capable of receiving operator preference input from a vehicle operator, for example, a human driver, regarding the fore-aft position of the pair of rear drive wheels 56L and 56R. Such an operator control panel 98 is preferably mounted within and/or to the body 60 of the vehicle 20A within a vehicle operator cabin 172 or proximate to a designated vehicle operator position. In addition, the operator control panel 98 is also electrically connected to the electronic controller 96. In such a configuration, the operator control panel 98 is capable of communicating electrical operator preference input information signals to the electronic controller 96 to thereby adjust the fore-aft position of the pair of rear drive wheels 56L and 56R as necessary, or as desired by the vehicle operator, to actively maintain the fore-aft stability of the vehicle 20A.

Also, as illustrated in FIG. 4, the vehicle 20A additionally includes a pair of attitude sensors 102L and 102R. Each attitude sensor 102L and 102R preferably includes conventional gyroscope technology and is therefore capable of sensing the everchanging attitude of the vehicle 20A as it travels across the ground 103 and over uneven terrain 104. Each attitude sensor 102L and 102R is preferably mounted to the frame 22 of the vehicle 20A and is electrically connected to the electronic controller 96. In such a configuration, the two attitude sensors 102L and 102R are capable of communicating electrical vehicle attitude information signals to the electronic controller 96 to thereby adjust the fore-aft position of the pair of rear drive wheels 56L and 56R as necessary to actively maintain the fore-aft stability of the vehicle 20A. To ensure functional cooperation with the two attitude sensors 102L and 102R, the electronic controller 96 includes, first of all, means for processing the electrical vehicle attitude information signals communicated from each attitude sensor 102L and 102R to thereby actively help determine the center of gravity 100 of the vehicle 20A with its cumulative onboard load as the vehicle 20A travels over uneven terrain 104. In addition, the electronic controller 96 also includes means for generating the electrical control signals according to the actively determined center of gravity 100 to thereby prompt the actuation system 90A to adjust the fore-aft position of the pair of rear drive wheels 56L and 56R as necessary to actively maintain the fore-aft stability of the vehicle 20A. Together, the electrical vehicle attitude information signals processing means and the electrical control signals generating means may be included on one or more electronic microprocessors associated with the electronic controller 96.

As particularly suggested in FIG. 4, the two attitude sensors 102L and 102R are preferably mounted to the frame 22 of the vehicle 20A on opposite sides of the vehicle 20A. In this way, the two attitude sensors 102L and 102R are capable of directly sensing the attitude of the vehicle 20A as the vehicle 20A travels over uneven terrain 104 and particularly uphill. Although having a single attitude sensor mounted to the frame 22 would generally suffice, having the two attitude sensors 102L and 102R situated on opposite sides of the vehicle 20A facilitates both cross-checking by the electronic controller 96 of the vehicle attitude information provided by the two attitude sensors 102L and 102R and also the taking into account of any flexing, twisting, or torsion of the frame 22 as the vehicle 20A travels over uneven terrain 104. Notwithstanding such an attitude sensor configuration, it is to be understood that many different attitude sensor positioning schemes on the frame or within the body of a vehicle pursuant to the present invention may alternatively be adopted.

Moreover, as illustrated in FIG. 4, the vehicle 20A further includes a plurality of load sensors 106L, 106R, and 106B. Each load sensor 106L, 106R, and 106B is capable of conventionally sensing a particular aspect of the cumulative load onboard the vehicle 20A such as, for example, the position and/or weight of the smaller, onboard individual loads that comprise the cumulative load. Such individual loads onboard the vehicle 20A may include, for example, a human load (i.e., the vehicle operator) in addition to any object load, for example, luggage, tools, equipment, and/or weapons. Given such, the load sensors in FIG. 4 particularly include, first of all, a left load sensor 106L and a right load sensor 106R situated at opposite corners of the front end 80 of the vehicle 20A. In addition, a total load sensor 106B is particularly included and situated proximate the axis 88 associated with the adjustable axle assembly 86A at the back end 82 of the vehicle 20A. Each such load sensor 106L, 106R, and 106B is preferably mounted to the frame 22 of the vehicle 20A and is electrically connected to the electronic controller 96. In such a configuration, each load sensor 106L, 106R, and 106B is capable of communicating electrical load information signals to the electronic controller 96 to thereby adjust the fore-aft position of the pair of rear drive wheels 56L and 56R as necessary to actively maintain the fore-aft stability of the vehicle 20A. To ensure functional cooperation with each load sensor 106L, 106R, and 106B, the electronic controller 96 includes, first of all, means for processing the electrical load information signals communicated from each load sensor 106L, 106R, and 106B to thereby actively help determine the center of gravity 100 of the vehicle 20A with its cumulative onboard load as the vehicle 20A travels over uneven terrain 104. In addition, the electronic controller 96 also includes means for generating the electrical control signals according to the actively determined center of gravity 100 to thereby prompt the actuation system 90A to adjust the fore-aft position of the pair of rear drive wheels 56L and 56R as necessary to actively maintain the fore-aft stability of the vehicle 20A. Together, the electrical load information signals processing means and the electrical control signals generating means may be included on one or more electronic microprocessors associated with the electronic controller 96.

Furthermore, as illustrated in FIG. 4, the vehicle 20A still further includes a pair of position sensors 108L and 108R. Each position sensor 108L and 108R is capable of conventionally sensing the fore-aft position of the adjustable axle assembly 86A onboard the vehicle 20A. Each position sensor 108L and 108R is preferably mounted to the frame 22 of the vehicle 20A such that each position sensor 108L and 108R is situated proximate to the axis 88 associated with the adjustable axle assembly 86A. In addition, each position sensor 108L and 108R is also electrically connected to the electronic controller 96. In such a configuration, each position sensor 108L and 108R is capable of communicating electrical axle assembly position information signals to the electronic controller 96 to thereby adjust the fore-aft position of the pair of rear drive wheels 56L and 56R as necessary to actively maintain the fore-aft stability of the vehicle 20A. To ensure functional cooperation with each position sensor 108L and 108R, the electronic controller 96 includes, first of all, means for processing the electrical axle assembly position information signals communicated from each position sensor 108L and 108R to thereby actively help determine the center of gravity 100 of the vehicle 20A with its cumulative onboard load as the vehicle 20A travels over uneven terrain 104. In addition, the electronic controller 96 also includes means for generating the electrical control signals according to the actively determined center of gravity 100 to thereby prompt the actuation system 90A to adjust the fore-aft position of the pair of rear drive wheels 56L and 56R as necessary to actively maintain the fore-aft stability of the vehicle 20A. Together, the electrical axle assembly position information signals processing means and the electrical control signals generating means may be included on one or more electronic microprocessors associated with the electronic controller 96.

During operation, as the vehicle 20A travels over the ground 103, the electronic controller 96 receives electrical vehicle attitude information signals from the attitude sensors 102L and 102R, electrical load information signals from the load sensors 106L, 106R, and 106B, and electrical axle assembly position information signals from the position sensors 108L and 108R on a substantially continuous basis. As all of these electrical information signals are received, the electronic controller 96 promptly processes the electrical information signals. In doing so, the electronic controller 96 thereby attempts to actively determine and monitor the position of the center of gravity 100 of the vehicle 20A together with its cumulative onboard load in relation to the ground contact points of both the two dolly wheels 48L and 48R and also the two rear drive wheels 56L and 56R.

Given that the vehicle 20A in this particular embodiment is a ZT vehicle, the vehicle 20A and its component parts are specifically dimensioned, weighted, and assembled such that the overall center of gravity 100 of the vehicle 20A together with its load is naturally predisposed to being well behind the ground contact points of the dolly wheels 48L and 48R and just in front of and over the ground contact points of the two rear drive wheels 56L and 56R when the two rear drive wheels 56L and 56R are in a position forward of the midpoint of the adjustable axle assembly movement range and the vehicle 20A is traveling over ground 103 that is substantially level. In light of such purposeful dimensioning and center of gravity predispositioning, when the vehicle 20A is traveling over substantially level ground and the electronic controller 96 actively determines that the center of gravity 100 of the vehicle 20A together with its cumulative onboard load is safely situated behind the ground contact points of the two dolly wheels 48L and 48R and also in front of the ground contact points of the two rear drive wheels 56L and 56R, the electronic controller 96 will accordingly generate situation-specific electrical control signals and communicate the electrical control signals to the actuation system 90A. In response to the electrical control signals, the actuation system 90A will then mechanically adjust (i.e., pivot) the adjustable axle assembly 86A only if and as needed to thereby position the two rear drive wheels 56L and 56R in an optimal retracted (forward) fore-aft position as generally illustrated in FIG. 6A. By adjusting the two rear drive wheels 56L and 56R into an optimal retracted fore-aft position in this manner, the vehicle 20A is thereby provided with less inhibited to total uninhibited zero turn capability and therefore increased maneuverability. If, on the other hand, the electronic controller 96 actively determines that the center of gravity 100 has suddenly shifted directly over or behind the ground contact points of the two rear drive wheels 56L and 56R while the vehicle 20A is traveling up a hill, the electronic controller 96 will accordingly generate situation-specific electrical control signals and communicate the electrical control signals to the actuation system 90A. In response to the electrical control signals, the actuation system 90A will then mechanically adjust the adjustable axle assembly 86A only as far as necessary toward a fully extended fore-aft position as in FIG. 6B to thereby shift the ground contact points of the two rear drive wheels 56L and 56R back behind the center of gravity 100. In this way, the front end of the vehicle 20A is kept on the ground 103 and the overall balance of the vehicle 20A is thereby safely maintained as the vehicle 20A continues to travel up the hill.

In situations, for example, where a vehicle operator fully anticipates traveling up a steep hill or firmly believes that the electronic controller 96 is receiving improper electrical information signals from a suspected malfunctioning sensor, the vehicle operator may opt to utilize the operator control panel 98 to manually enter operator preference input regarding his choice for moving the pair of rear drive wheels 56L and 56R into a particular fore-aft position. Once the vehicle operator enters his particular fore-aft position preference, electrical operator preference input information signals are communicated to the electronic controller 96. In response to receiving such electrical operator preference input information signals, the electronic controller 96 then ignores all other electrical information signals and promptly communicates electrical control signals to the actuation system 90A in accordance with the particular preference of the vehicle operator. As a result, the fore-aft position of the pair of rear drive wheels 56L and 56R is ultimately adjusted to maintain the fore-aft stability of the vehicle 20A according to the vehicle operator's best judgment. Thus, in this way, a vehicle operator can utilize the operator control panel 98 to manually override the actively adjustable axle system 131A of the vehicle 20A as desired and as necessary.

In summary, the first embodiment 20A of the vehicle 20 according to the present invention realizes many advantages over other off-road or all-terrain vehicles, and particularly ZT vehicles, commonly in use today. In particular, with its purposeful dimensioning, weight distribution, and predisposed center of gravity along with the actively adjustable axle system 131A, the vehicle 20A according to the present invention (1) successfully maintains its balance when traveling directly up a hill, (2) successfully maintains its balance when traveling across a hillside, (3) successfully maintains its balance even when a vehicle operator attempts rapid acceleration or sudden braking, (4) successfully maintains its balance when traveling over terrain with extreme and everchanging topographies, (5) successfully maintains its balance and optimizes traction even when there are significant and frequent changes in human load and/or object load onboard, (6) successfully maintains its balance even under reduced traction conditions, (7) is not unnecessarily limited in maximum zero turn capability when suited for use as a zero turn (ZT) vehicle, and (8) may successfully be adapted or suited for use as either a ZT vehicle or a non-ZT vehicle.

This concludes the detailed description of both the structure and operation of the first embodiment 20A of the vehicle 20 according to the present invention.

### 2. Alternative Embodiments

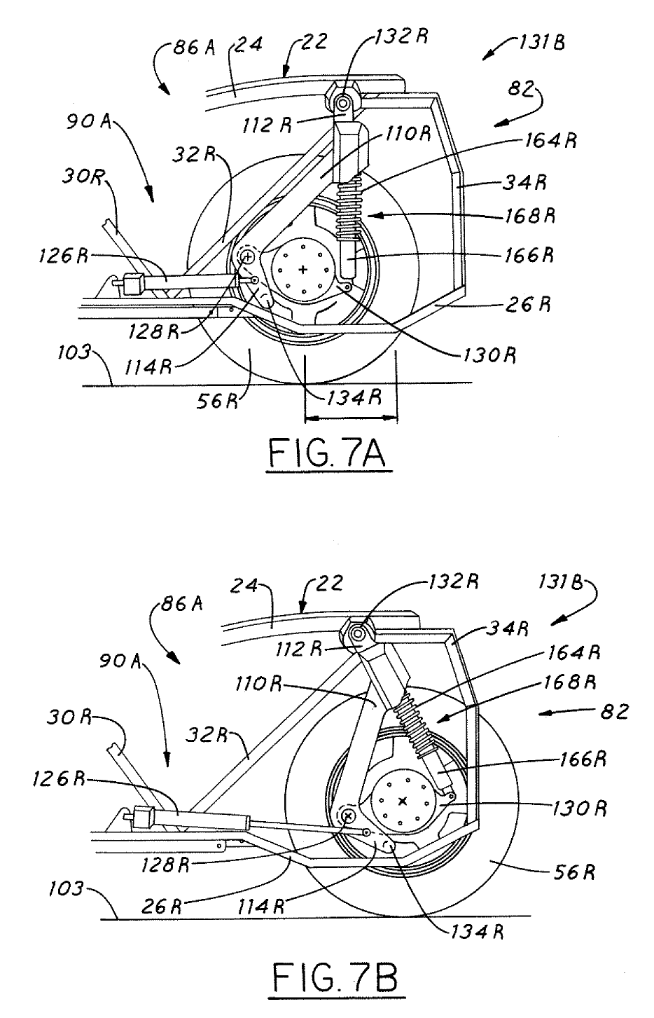

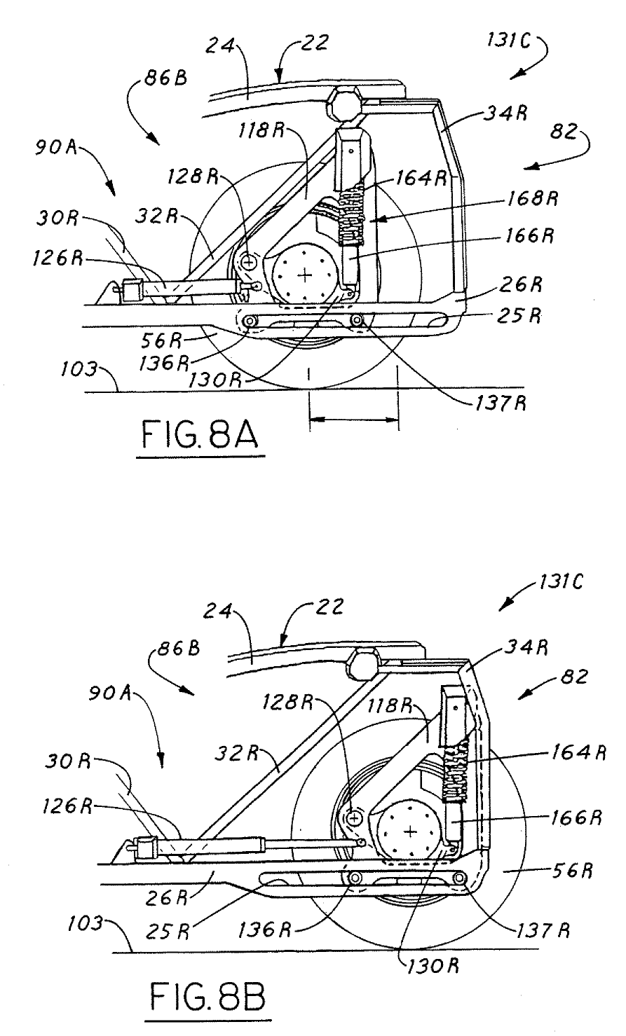

An alternative embodiment 131B of the actively adjustable axle system 131 is illustrated in FIGS. 7A and 7B. As illustrated, the alternative embodiment 131B of the actively adjustable axle system 131, as does the first embodiment 131A, generally includes the first embodiment 86A of the adjustable axle assembly 86, the first embodiment 90A of the actuation system 90, and the electronic controller 96. However, in contrast to the first embodiment 131A, the two telescoping cylinders 126L and 126R of the actuation system 90A in this alternative embodiment 131B are instead connected between the frame 22 of the vehicle 20A and the two swing arms 110L and 110R proximate their distal ends 114L and 114R. In such a configuration, when the two telescoping cylinders 126L and 126R are fully contracted, the two swing arms 110L and 110R of the adjustable axle assembly 86A along with the two rear drive wheels 56L and 56R are thereby moved (i.e., pivoted) into a fully retracted (forward) fore-aft position as illustrated in FIG. 7A. On the other hand, when the two telescoping cylinders 126L and 126R are fully expanded, the two rear drive wheels 56L and 56R are thereby moved in a fully extended (rearward) fore-aft position as illustrated in FIG. 7B.

Another alternative embodiment 131C of the actively adjustable axle system 131 is illustrated in FIGS. 8A and 8B. As illustrated, the actively adjustable axle system 131C includes a second embodiment 86B of the adjustable axle assembly 86, the first embodiment 90A of the actuation system 90, and the electronic controller 96. The adjustable axle assembly 86B itself includes a pair of slide arms 118L and 118R as well as a second embodiment 116B of the cross arm assembly 116. The two slide arms 118L and 118R, first of all, are slidingly engaged within two slots 25L and 25R defined within the frame 22 of the vehicle 20A. The cross arm assembly 116B, in turn, includes both a first cross arm (not shown) that interconnects the two slide arms 118L and 118R at attachment points 136L and 136R and also a second cross arm (not shown) that similarly interconnects the two slide arms 118L and 118R at attachment points 137L and 137R. Given such an adjustable axle assembly 86B, the rear drive wheels 56L and 56R in this alternative embodiment 131C are instead rotatably suspended from the slide arms 118L and 118R. The two telescoping cylinders 126L and 126R of the actuation system 90A, in cooperation therewith, are connected between the frame 22 of the vehicle 20A and the two slide arms 118L and 118R. In such a configuration, when the two telescoping cylinders 126L and 126R are fully contracted, the two slide arms 118L and 118R of the adjustable axle assembly 86B along with the two rear drive wheels 56L and 56R are thereby moved (i.e., slid) into a fully retracted (forward) fore-aft position as illustrated in FIG. 8A. On the other hand, when the two telescoping cylinders 126L and 126R are fully expanded, the two rear drive wheels 56L and 56R are thereby moved into a fully extended (rearward) fore-aft position as illustrated in FIG. 8B.

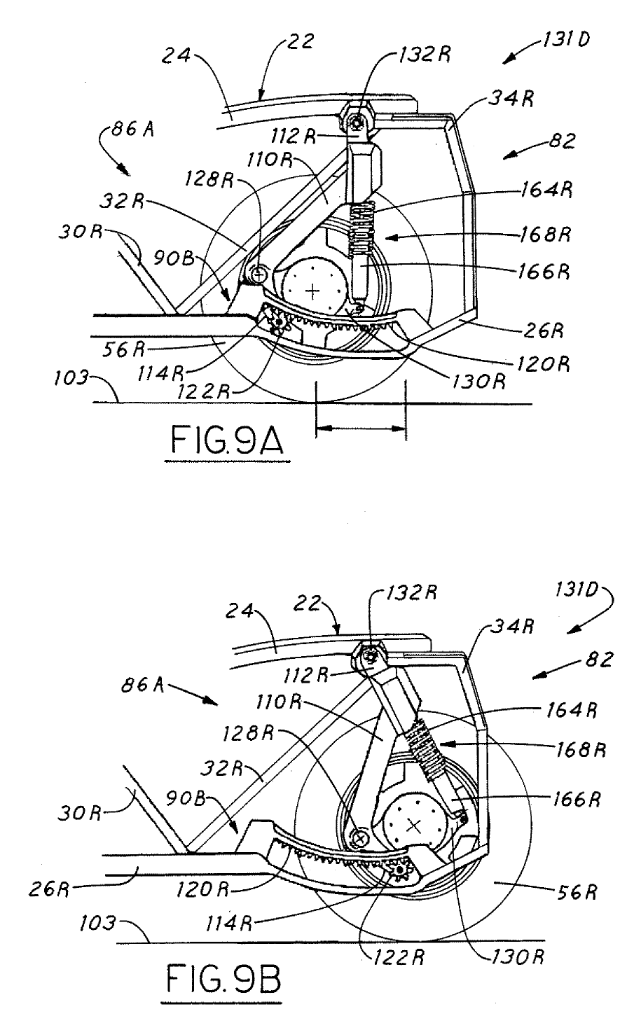

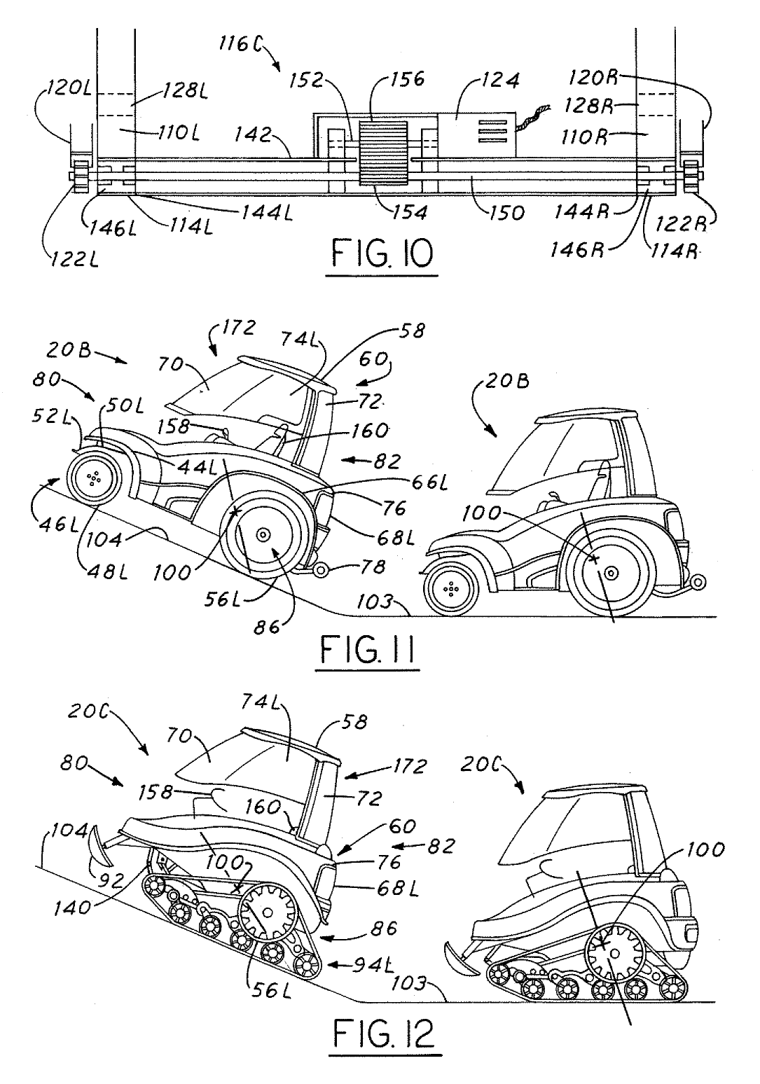

Still another embodiment 131D of the actively adjustable axle system 131 is illustrated in FIGS. 9A, 9B, and 10. As illustrated, the actively adjustable axle system 131D includes the first embodiment 86A of the adjustable axle assembly 86, a second embodiment 90B of the actuation system 90, and the electronic controller 96. The actuation system 90B itself includes a pair of racks 120L and 120R, a pair of pinion gears 122L and 122R, and an electric motor 124. The two racks 120L and 120R, first of all, are fixed to the frame 22 of the vehicle 20A. The two pinion gears 122L and 122R, in turn, are generally rotatably mounted to the distal ends 114L and 114R of the two swing arms 110L and 110R such that the two pinion gears 122L and 122R are engaged with the two racks 120L and 120R. The electric motor 124, lastly, is preferably a stepping-type motor that is electrically connected to the electronic controller 96 and thereby microprocessor-controlled.

In cooperation with such an actuation system 90B, the cross arm assembly 116 of the adjustable axle assembly 86A has a third embodiment 116C, as particularly illustrated in FIG. 10, adapted to include a hollow cross arm 142. The hollow cross arm 142, first of all, interconnects the two swing arms 110L and 110R in a fixed fashion at attachment points 144L and 144R. The hollow cross arm 142, in addition, includes a rotatable pinion shaft 150 within its hollow having opposite ends that are rotatably received and mounted within bearings 146L and 146R situated within the distal ends 114L and 114R of the two swing arms 110L and 110R. The two pinion gears 122L and 122R are both particularly fixed onto the rotatable pinion shaft 150 proximate the opposite ends thereof such that the two pinion gears 122L and 122R rotate in unison with the rotatable pinion shaft 150. Within such a cross arm assembly 116C, the electric motor 124, in addition to being electrically connected to the electronic controller 96, is also mounted onto the exterior of the hollow cross arm 142 in a fixed fashion such that a rotatable output drive shaft 152 protruding from the electric motor 124 is substantially parallel with the rotatable pinion shaft 150. Upon the protruding end of the rotatable output drive shaft 152, a primary drive gear 156 is fixed thereon such that the rotatable output drive shaft 152 and the primary drive gear 156 rotate in unison. A mating drive gear 154 fixed onto or integral with the middle portion of the rotatable pinion shaft 150 is meshingly engaged with the primary drive gear 156.

Within such a configuration as depicted in FIGS. 9A, 9B, and 10, the electronic controller 96 during operation is capable of communicating electrical control signals to the electric motor 124. In response, the electric motor 124 then “steps” or rotates the output drive shaft 152 along with the primary drive gear 156 in accordance with the electrical control signals received from the electronic controller 96. As both the output drive shaft 152 and the primary drive gear 156 rotate, the mating drive gear 154 engaged with the primary drive gear 156 accordingly causes concomitant rotation in both the pinion shaft 150 and the two pinion gears 122L and 122R fixed thereon. In this way, stepped or incremental movement of the two pinion gears 122L and 122R in either direction along the two racks 120L and 120R is ultimately realized. As a direct result, the adjustable axle assembly 86A is correspondingly moved (i.e., pivoted), thereby adjusting the fore-aft position of the two rear drive wheels 56L and 56R as necessary to actively maintain the fore-aft stability of the vehicle 20A during operation.

A slightly alternative embodiment 20B of the vehicle 20 is illustrated in FIG. 11. As illustrated, the vehicle 20B includes a seat 160 for accommodating a vehicle operator within the vehicle operator cabin 172. In addition to the seat 160, the vehicle 20B also includes an operator steering control 158 incorporated within the operator control panel 98 (see FIG. 4) situated in the vehicle operator cabin 172. Furthermore, the vehicle 20B also includes a wheelie bar 78 mounted to the rear end 82 of the vehicle 20B for helping prevent the vehicle 20B from being altogether upended should the front end 80 of the vehicle 20B ever come off the ground when traveling up a steep hill.

As clearly demonstrated in FIG. 11, when the vehicle 20B is traveling over ground 103 that is substantially level, the actively adjustable axle system 131 will generally maintain the adjustable axle assembly 86 along with the two rear drive wheels 56L and 56R in a fully retracted (forward) fore-aft position. Such is appropriate, first of all, since the center of gravity 100 of the vehicle 20B with its cumulative onboard load as actively determined by the electronic controller 96 is safely situated behind the ground contact points of the two dolly wheels 48L and 48R and also just in front of the ground contact points of the two rear drive wheels 56L and 56R. That is, the center of gravity 100 of the vehicle 20B with its cumulative onboard load is safely situated over both the two dolly wheels 48L and 48R and the two rear drive wheels 56L and 56R such that the vehicle 20B will not tip over and become altogether upended and also such that maximum traction is realized by the two rear drive wheels 56L and 56R. Such is appropriate also because maintaining the rear drive wheels 56L and 56R in a fully retracted (forward) fore-aft position whenever feasible provides the vehicle 20B with enhanced, axle-centric balance for maximizing zero turn capability and therefore increased maneuverability. When, on the other hand, the vehicle 20B is traveling over ground 103 that includes uneven terrain 104 necessitating travel up a steep hill, the actively adjustable axle system 131 will then adjust the adjustable axle assembly 86 along with the two rear drive wheels 56L and 56R toward an extended (rearward) fore-aft position as necessary to thereby safely maintain the overall balance of the vehicle 20B. Any such necessary adjustment is timely initiated by the electronic controller 96 in response to its own active determination of the center of gravity 100 of the vehicle 20B with its cumulative onboard load.

Another alternative embodiment 20C of the vehicle 20 is illustrated in FIG. 12. As illustrated, the vehicle 20C uniquely includes, first of all, an anti-tip disc 92 serving as a supplemental ground-interacting apparatus for the purpose of safety. In addition, the vehicle 20C also uniquely includes a pair of ground-interacting track assemblies 94L and 94R. Such ground-interacting track assemblies 94L and 94R are preferably mounted to both the adjustable axle assembly 86 and a forward suspension 140 of the vehicle 20C such that the two rear drive wheels 56L and 56R are engaged within the two ground-interacting track assemblies 94L and 94R to thereby facilitate moving interaction with the ground 103. As clearly demonstrated in FIG. 12, when the vehicle 20C is traveling over ground 103 that is substantially level, the actively adjustable axle system 131 will generally maintain the adjustable axle assembly 86 along with both the two rear drive wheels 56L and 56R and also the two track assemblies 94L and 94R in a fully retracted (forward) fore-aft position. When, on the other hand, the vehicle 20C is traveling over ground 103 that includes uneven terrain 104 necessitating travel up a steep hill, the actively adjustable axle system 131 will then adjust the adjustable axle assembly 86 along with both the two rear drive wheels 56L and 56R and also the two track assemblies 94L and 94R toward an extended (rearward) fore-aft position as necessary to thereby safely maintain the overall balance of the vehicle 20C.

While the present invention as described hereinabove was initially conceived in response to particular difficulties experienced with the performance and design of ZT vehicles, it is to be understood that the present invention is largely relevant and applicable to non-ZT vehicles as well. That is, many of the basic inventive principles implemented herein to improve the overall performance and design of ZT vehicles are applicable to many non-ZT vehicles as well. In particular, upon reading this invention disclosure, it is believed that one skilled in the art would readily realize that the inventive principles taught herein, for example, (1) actively determining the center of gravity of a vehicle with its cumulative onboard load to thereby maintain vehicle balance, (2) actively responding to shifts in vehicle attitude while the vehicle travels over extreme and everchanging terrain to thereby maintain vehicle balance, (3) actively responding to significant and frequent changes in human load and/or object load onboard the vehicle to thereby maintain vehicle balance, and (4) actively extending and/or retracting a two-wheeled axle of the vehicle as necessary to thereby optimize both vehicle maneuverability and vehicle balance, may also be applied to many non-ZT vehicles as well.

While having independent front or rear 2-wheel drive is primarily characteristic of ZT vehicles, it is to be understood that a vehicle pursuant to the present invention may alternatively have dependent front or rear 2-wheel drive capability, 4-wheel drive capability, or even all-wheel drive capability. In addition, with regard to suspension systems, a vehicle pursuant to the present invention may have an independent, non-independent, or semi-independent suspension system. Also, with regard to suspension system springs, a vehicle pursuant to the present invention may, as an alternative to coil springs, instead include leaf springs, air springs, or torsion bar springs. Moreover, with regard to vehicle steering systems, a vehicle pursuant to the present invention may, as an alternative to having two dolly wheels and two wheels with independent 2-wheel drive, instead have two largely non-steerable wheels and two wheels directly steerable with a traditional linkage or rack-and-pinion steering system. Furthermore, with regard to the actuation system, it is to be understood that many different types of actuators may alternatively be utilized on a vehicle pursuant to the present invention, including, for example, hydraulic, electric, pneumatic, or mechanical linkage type actuators, or even combinations thereof. Still further, any actuation system incorporating one or more of such actuators may optionally be designed to adjust the fore-aft positions of vehicle wheels either together in pairs or independently and individually pursuant to the present invention.

In summary, the vehicle with actively adjustable axle system for traveling over uneven terrain with a load, as described hereinabove within its various preferred embodiments according to the present invention, realizes many advantages over other off-road or all-terrain vehicles commonly in use today. In particular, the vehicle according to the present invention (1) successfully maintains its balance when traveling directly up a hill, (2) successfully maintains its balance when traveling across a hillside, (3) successfully maintains its balance even when a vehicle operator attempts rapid acceleration or sudden braking, (4) successfully maintains its balance when traveling over terrain with extreme and everchanging topographies, (5) successfully maintains its balance and optimizes traction even when there are significant and frequent changes in human load and/or object load onboard, (6) successfully maintains its balance even under reduced traction conditions, (7) is not unnecessarily limited in maximum zero turn capability when suited for use as a zero turn (ZT) vehicle, and (8) may successfully be adapted or suited for use as either a ZT vehicle or a non-ZT vehicle.

In general, a vehicle having a single primary axle with independent drive and speed control of each of the two wheels provides maneuverability known by those knowledgeable in the art as zero turn capability. Such a vehicle provides significant advantages in maneuverability, but has characteristics of operation that are unique to such a vehicle having a single axle that is utilized for both traction and steering control. This vehicle, as discussed hereinabove, has some disadvantages, including when operated on the sides of hills. This is particularly true when a heavier weighting of the front of the vehicle, which is generally supported by dolly wheels that provide no directional stability, results in a tendency for the heavier front weight to pull the front of the vehicle downhill. With the additional characteristic of the vehicle having less traction on the uphill drive wheel due to the side slope effectively shifting weight of the vehicle to the downhill drive tire, slippage of this uphill tire allows this undesired turning of the heavier front of the vehicle weight down the hill. In the case of a single axle lower drive wheel, the single tire's single point of contact with the ground offers little resistance to rotating in the horizontal plane. The same rotational result can occur when braking rapidly with the uphill wheel having less traction than the downhill wheel, resulting in skidding of the uphill wheel before that of the downhill wheel, thus effectuating vehicle rotation or unwanted steering since the front dolly wheels offer no resistance to the rotation of the vehicle.

Vehicle embodiments discussed hereinabove provide at least one solution for addressing both vehicle balance and tractive capability, which has a direct impact on steering stability in the conditions mentioned above. In accordance with this solution, the additional drive and steering capability is achieved with the vehicle weight being balanced on the single drive axle, this being achieved by the movement of the drive axle for the centering of the vehicle balance over this single axle. A further “mechanical” mechanism for rotational (or steering) stability of this zero-turn vehicle would further the vehicle's capabilities in extreme operating conditions. For example, another set of tires that operate in the same fore-aft axis, forward or rearward of the single tire, would provide assistance both through additional traction and the mechanical effect of placing a second point on the ground, thereby eliminating the single point rotational center.

A rigid frame four-wheel drive vehicle, such as a skid-steer loader, that is made to turn, including zero-turn operation, by varying the rotation and speed of the right and left drive wheels causes skidding of the tires at contact with the ground. In contrast, a vehicle having what is known in the industry as zero-turn capability by means of a single drive axle and having front caster wheels, is highly maneuverable without the wheels causing scuffing on the ground. This type of vehicle has little, or no, skidding of the turning wheels that generate directional change. While the four-wheel drive skid-steer vehicles are also highly maneuverable, they either have little fore-aft stability at high speed due to a short wheelbase intended to minimize the skidding and scuffing, or the tires are spread as far apart as possible for stability and thus the vehicle has excessive scuffing and skidding during rotational turning. General designs of these vehicles attempt a balance of the two conflicting criteria for a medium result, thereby achieving neither high-speed fore-aft stability nor non-scuff rotational turning.

A vehicle that could effectively combine the characteristics of both skid-steer and spin-steer vehicles would be able to have greater fore-aft stability, particularly at high speeds, and also less scuffing of the ground at the points of contact of the steering tires. If a further addition to this combination included the ability of the four-wheel drive mechanism to be actively moved relative to the vehicle weight in all operations and loading of the vehicle, the wheel spacing could be reduced to thereby reduce scuffing during zero-turning with the weight balanced over the four-wheel drive mechanism, and the overall wheelbase relative to the front stabilizing wheels (for example, dolly wheels) could be lengthened during high-speed travel for greater fore-aft stability and ride comfort.

In general, an ideal stability for high-speed driving can be achieved via direct steering of the front wheels of a vehicle and also the vehicle having a long wheelbase. However, such a configuration is generally not conducive to rapid or smooth zero-turn operation. If, however, the steering wheels were off the ground during any such radical zero-turning operation, these wheels would not cause drag or skidding.

Furthermore, a vehicle with a drive track assembly that is able to be installed as a module in place of dual drive tires, and possible use of steering skis in the front of the vehicle, would also utilize the advantages achieved with the shifting dual drive axles, with improved fore-aft stability and hillside steering stability over that of a zero turn vehicle utilizing tires, much the same as with fore-aft dual tires as described above. However, front skis in a standard snowmobile configuration generally do not allow zero-turn capability. Without a front ski stabilizing the vehicle's fore-aft dimension, a long track helps provide such desired fore-aft stability, while a short track is of distinct advantage for a vehicle of zero turn capabilities. Thus, similar to the discussion hereinabove, a track assembly that is able to move under the vehicle for balance, utilized in conjunction with the capability of rotation of the track chassis relative to the vehicle for the lifting of the front of the vehicle to get the front ski(s) off the ground, allows zero-turn capability to be most fully realized on a vehicle. A dolly wheel, or front drive wheel, positioned in front of the shifting oscillating track assembly units can also have advantages in all-terrain use, with the track chassis rotating relative to the vehicle so as to allow lifting of such a front wheel configuration, thereby effecting complete zero-turn capability.

Discussed hereinabove is a personal zero-turn vehicle system that provides vehicle balance over one drive axle. In this vehicle, balance is maintained by a system of gyroscopic sensors in communication with an electronic controller in communication with drive wheel motors such that the wheels rotate and drive such that they stay under the vehicle's overall load. This system, however, sometimes may suffer in extreme conditions of limited traction, such as on snow and/or ice, where instantaneous traction necessary for drive wheel movement to correct any balance changes is not always available.

Thus, it would be ideal for a vehicle to have balancing capabilities that implement the advantageous features of the above-described zero-turn vehicles, but also with further enhanced traction capability and mechanical stability that allows all-weather, all-terrain, and all-speed capability.

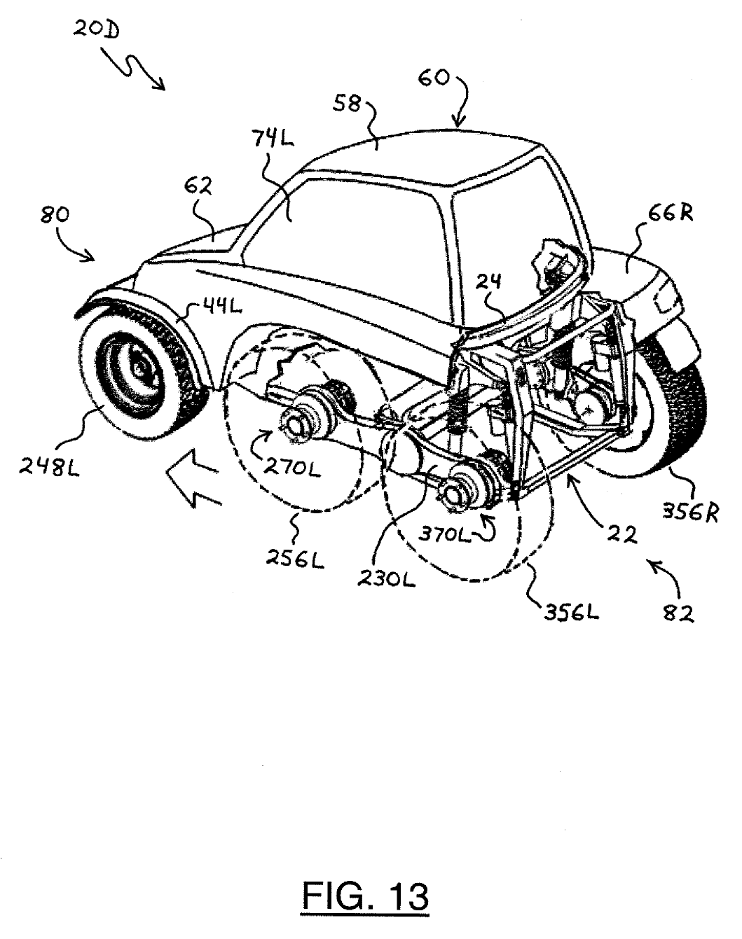

FIGS. 13 through 17D together illustrate a fourth embodiment 20D of the vehicle 20 according to the present invention. As shown, the vehicle 20D includes a body 60, a frame 22, a pair of front wheels 248L and 248R, an adjustable axle assembly 286, two pairs of rear wheels 256L and 256R and also 356L and 356R, and an actuation system 290. The body 60 is mounted to the frame 22, and the frame 22 has front and rear ends 80 and 82 with a fore-aft 84 axis extending therebetween. The front wheels 248L and 248R are rotatably mounted opposite each other at the front end 80 of the frame 22, and the adjustable axle assembly 286 is mounted at the rear end 82 of the frame 22 substantially orthogonal to the fore-aft axis 84. The wheels 256L and 256R and also 356L and 356R in each of the two pairs of rear wheels are rotatably mounted opposite each other at the ends of the adjustable axle assembly 286. The actuation system 290 is capable of mechanically moving the adjustable axle assembly 286 to thereby adjust the fore-aft positions of the rear wheels 256L, 256R, 356L, and 356R relative to the frame 22. In this same embodiment, the vehicle 20D may further include a second actuation system 390. The second actuation system 390 is capable of mechanically rotating the adjustable axle assembly 286 to thereby adjust the heights of the rear wheels 256L, 256R, 356L, and 356R relative to the frame 22.

Though the front wheels 248L and 248R of the vehicle 20D may be non-steerable wheels such as dolly wheels or caster wheels, the front wheels 248L and 248R are preferably steerable to thereby enhance vehicle stability and balance when the vehicle 20D is traveling at a high rate of speed. Both the first pair of rear wheels 256L and 256R and the second pair of rear wheels 356L and 356R are preferably independently operable drive wheels to thereby facilitate skid-steer turning that approximates zero turn capability.

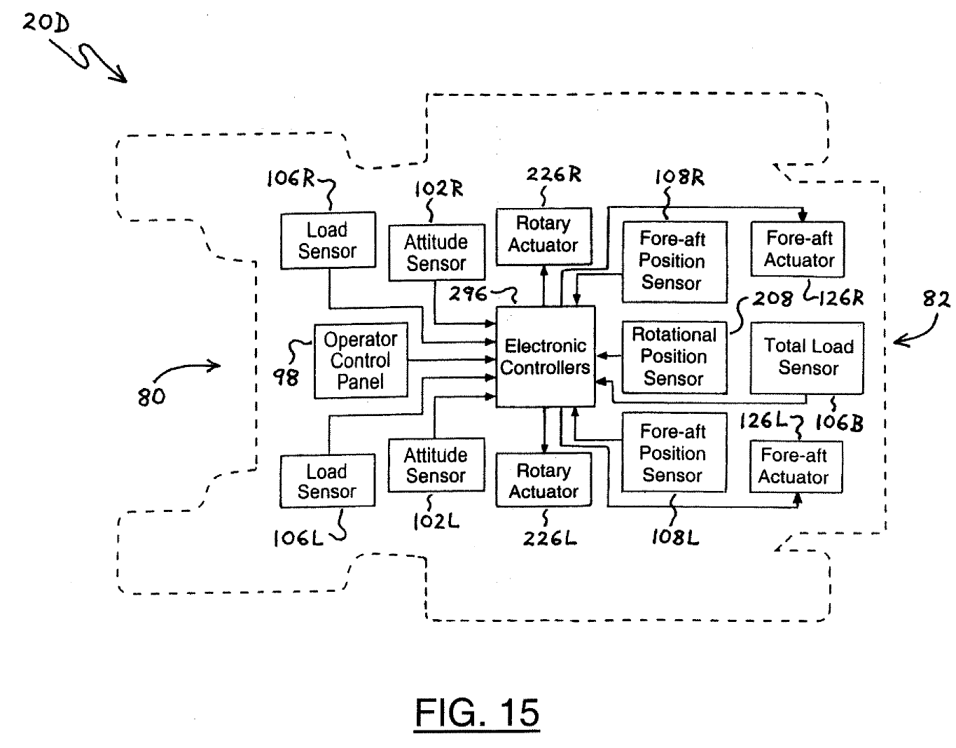

As illustrated in the block diagram of FIG. 15, the vehicle 20D may further include one or more electronic controllers 296 onboard. In one practicable embodiment, such an electronic controller 296 may be mounted to the body 60 and electrically connected to one or more fore-aft actuators 126L and 126R of the first actuation system 290. In such a configuration, the electronic controller 296 is capable of communicating electrical control signals to the actuation system 290 to thereby adjust the fore-aft positions of the first and second pairs of rear wheels as necessary to actively help maintain the fore-aft balance and stability of the vehicle 20D.

In the same or other embodiment, the vehicle 20D may include an electronic controller 296 mounted to the body 60 and electrically connected to one or more rotary actuators 226L and 226R of the second actuation system 390. In such a configuration, the electronic controller 296 is capable of communicating electrical control signals to the second actuation system 390 to thereby permit free and oscillatory rotation of the adjustable axle assembly 286 as necessary to help maintain all front wheels 248L and 248R and all rear wheels 256L, 256R, 356L, and 356R on the ground. In this same or other configuration, the electronic controller 296 may alternatively be capable of communicating electrical control signals to the second actuation system 390 to thereby adjust the heights of the first and second pairs of rear wheels as necessary to actively help maintain all front wheels 248L and 248R and all rear wheels 256L, 256R, 356L, and 356R on the ground. Also, in this same or other configuration, the electronic controller 296 may alternatively be capable of communicating electrical control signals to the second actuation system 390 to thereby adjust the heights of the first and second pairs of rear wheels as necessary to lift and actively help maintain one of either the pair of front wheels 248L and 248R, the first pair of rear wheels 256L and 256R, or the second pair of rear wheels 356L and 356R off the ground. Furthermore, in this same or other configuration, the electronic controller 296 may alternatively be capable of communicating electrical control signals to the second actuation system 390 to thereby adjust the heights of the first and second pairs of rear wheels as necessary to actively help maintain the body 60 at a pre-selected pitch as desired, for example, by a driver or operator of the vehicle 20D.

In a fifth practicable embodiment 20E (not illustrated) of the vehicle 20 somewhat similar to the third embodiment 20C discussed earlier hereinabove, the vehicle 20E may alternatively include a body, a frame, at least one ski, an adjustable axle assembly, a pair of drive track assemblies, a first actuation system, and a second actuation system. The body is mounted to the frame, and the frame has front and rear ends with a fore-aft axis extending therebetween. Each ski is mounted at the front end of the frame, and the adjustable axle assembly is mounted at the rear end of the frame substantially orthogonal to the fore-aft axis. The drive track assemblies are mounted opposite each other at the ends of the adjustable axle assembly. The first actuation system is capable of mechanically moving the adjustable axle assembly to thereby adjust the fore-aft position of the drive track assemblies relative to the frame. The second actuation system is capable of mechanically rotating the adjustable axle assembly to thereby adjust the pitch of the drive track assemblies relative to the frame.

In such a fifth embodiment 20E of the vehicle 20, the vehicle 20E may further include one or more electronic controllers onboard. In one practicable embodiment, such an electronic controller may be mounted to the body and electrically connected to the first actuation system. In this configuration, the electronic controller is capable of communicating electrical control signals to the first actuation system to thereby adjust the fore-aft position of the pair of drive track assemblies as necessary to actively help maintain the fore-aft balance and stability of the vehicle 20E. In the same or other embodiment, an electronic controller may be mounted to the body and electrically connected to the second actuation system. In this configuration, the electronic controller is capable of communicating electrical control signals to the second actuation system to thereby adjust the pitch of the pair of drive track assemblies as necessary to lift and actively help maintain each front ski off the ground.

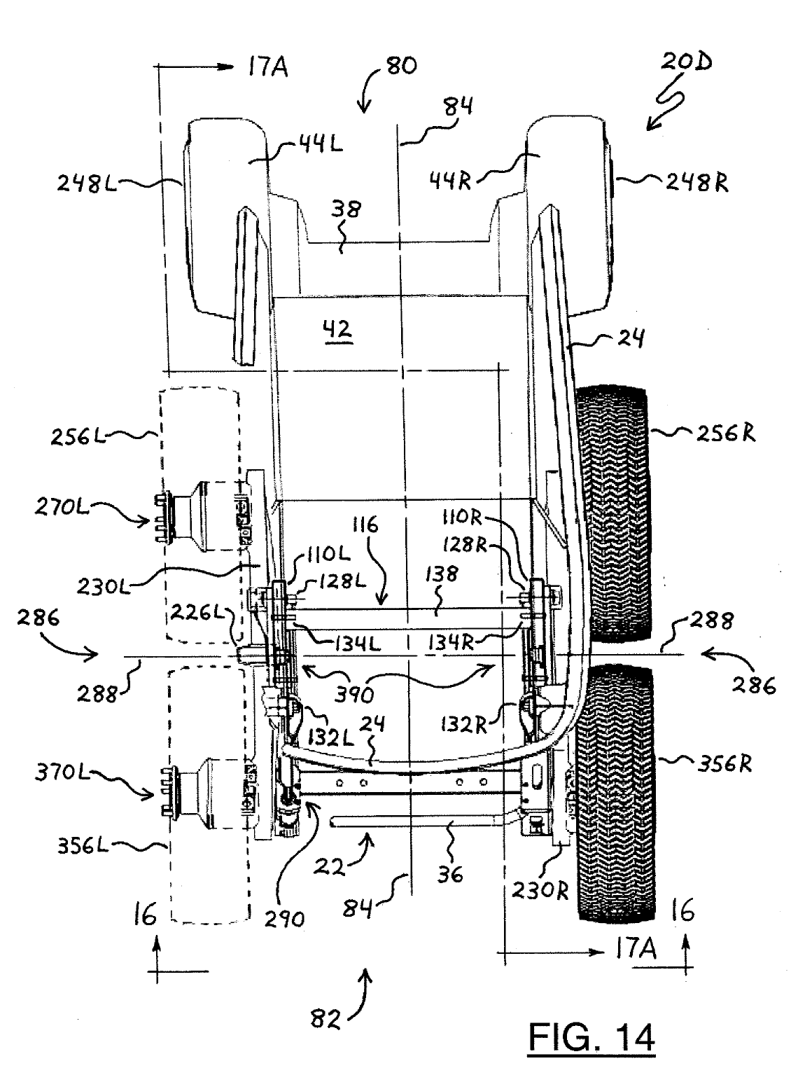

In embodiments 20D and 20E of the vehicle 20, the combination of a moveable dual fore-aft axle system to balance the vehicle over its axle assembly and also a two pairs of wheels fore-aft axle format helps provide a balanced and stable vehicle base in conditions of poor traction and also facilitates aggressive zero-turn capability. Herein, it is to be understood that some practicable embodiments of the vehicle 20 may include an electronic rotational controller 296 for the adjustable dual axle assembly, as best shown in FIGS. 14, 15, and 17A through 17D. Such an electronic rotational controller, during operation, is capable of (1) holding the adjustable dual axle in a rigid or locked position, (2) modulating the dual axle system to effectuate a fore-aft tilt of the vehicle, or (3) releasing rotational control of the adjustable axle assembly for free oscillation thereof so as to accommodate everchanging terrain when traveling with the help and use of front steering tires or front steering skis. In this way, the vehicle has increased balance and stability at high rates of speed and also enhanced maneuverability (i.e., zero turn capability) at low speeds.

In embodiments 20D and 20E of the vehicle 20, it is therefore an object of the present invention to provide an oscillating dual axle drive wheel system that is mounted in such a way so as to allow powered movement of the axle system forward and rearward relative to the vehicle.

It is further an object of the present invention to provide a pivoted system that carries a suspension for the oscillating dual axle drive wheel system, with suspension being wholly linked to both sides of the dual axle system or independent in operation to each side of the dual drive axle system. It is to be understood by those in the art that the drive axle suspension could also be dependent and utilize the adjustment controls as a component of the suspension.

It is further an object of the present invention that the oscillating dual axle moveable drive wheel system is in communication with one or more electronic controllers having various associated sensors that are capable of sensing change of slope (i.e., attitude sensors 120L and 120R) and vehicle loading (i.e., load sensors 106L, 106R, and 106B) such that the sensors, by way of communication through the controller, effectuate movement of the drive axle system to adjust the weight balance of the vehicle above its drive axle such that the vehicle maintains desired fore-aft stability on the free oscillating center of the dual axle system.

It is further an object of the present invention that the moveable oscillating dual axle drive system may be provided with powered control of the oscillation of the dual axle so as to effectuate greater load on one or the other of the dual drive wheel pairs, including the lifting of one of the wheel pairs off the ground, or of effectuating the tilting of the entire vehicle utilizing a combination of the controlled oscillation (i.e., rotation) and fore-aft adjustability of the axle system.

It is further an object of the present invention that the moveable dual axle drive system may utilize mounting so as to have an unsuspended assembly, individual independent “A” arm type suspensions mounted thereon, utilize a knee action swing arm suspension component integral with the pivotally mounted drive axle carrying the dual axle oscillation pivot, utilize an active independent linear motor type suspension, or other suspension method in conjunction with the moveable drive axle system.

It is to be understood that activation of the movable axle system may be effectuated by a variety of different methods or actuators such as, for example, a hydraulic cylinder, an electric actuator, a rotary actuator, a linear electric motor, mechanical linkage, and manual changes, as known by those skilled in the art. Furthermore, movement and/or motion of the movable axle may be accomplished by a variety of methods such as a pivoting system, a sliding system, a mechanical linkage system, and manual changes, as known by those skilled in the art.

It is further an object of this invention that activation of controlled oscillation or rotation of the dual axle system, independent or dependent, right or left side of the vehicle, may be effectuated by a variety of different methods or actuators such as, for example, rotary hydraulic control, an active electric stepper motor, a hydraulic cylinder, a linear electric motor, mechanical linkage, an electric actuator, as known by those skilled in the art.

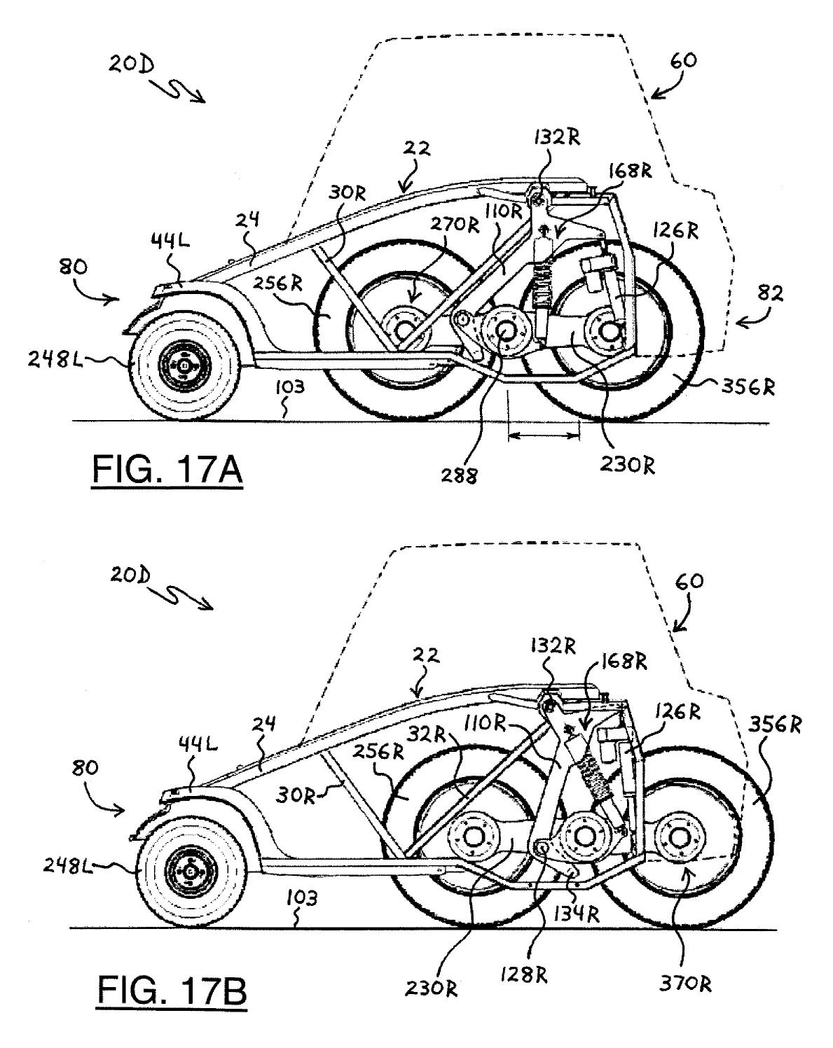

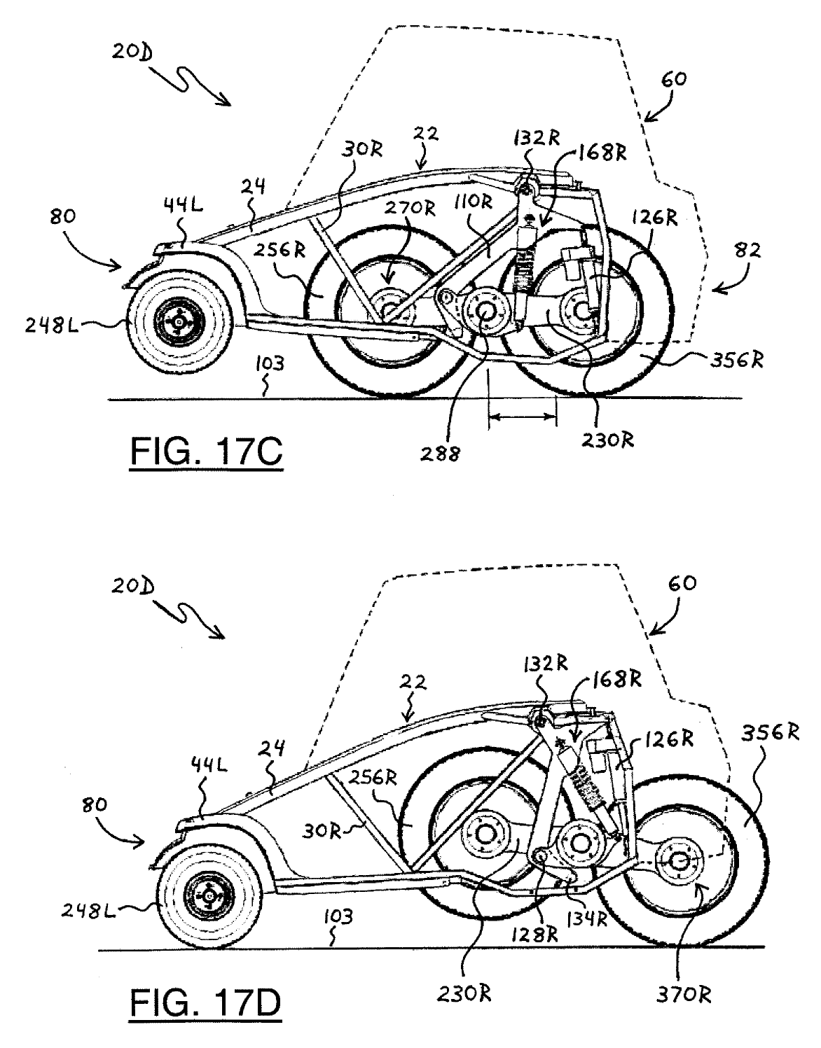

It is further an object of the present invention that the moveable oscillating dual axle system and the traction and stability effect resulting from the appropriate movement of the oscillating dual drive axle relative to vehicle balance allows accounting for operation on steep slopes, sudden acceleration or braking, or for changes in vehicle loading and vehicle wheelbase configuration. By way of example, FIG. 17C illustrates a side view of the present invention as used on a vehicle having a personal mobility or utility usage where the forward position of the dual axle in conjunction with a powered oscillation of the dual axle system effects a lifting of the front of the vehicle allowing a skid-steer zero-turning capability. FIG. 17D, on the other hand, illustrates a side view of the present invention as used on a vehicle having a personal mobility or utility usage where the rearward position of the dual axle in conjunction with a powered oscillation of the dual axle system effects a lifting of the first pair of rear wheels on the dual axle system to provide a stable, long-wheelbase, two-wheel drive (2WD) or four-wheel drive (4WD) vehicle configuration. As a result, steering capabilities of vehicles with multiple axle drives can now be seen as advantageous for application on vehicles of utility and/or mobility, such as, for example, turf-care vehicles, agricultural vehicles, construction vehicles, personal transportation vehicles, military mobility vehicles, utility vehicles, and delivery vehicles.

In summary, therefore, the present invention of a moveable dual drive axle system utilizes a controller to move a drive axle system forward and rearward relative to the vehicle such that the relationship of the vehicle center of gravity relative to the centerline of the pivot of said dual drive axle system is changed. The moveable drive axle system may further be in communication with a controller having sensors capable of sensing change of slope and vehicle loading such that the sensors, in communication through the controller, effectuate movement of the dual drive axle system to adjust the weight balance of the vehicle above the dual drive axle such that the vehicle maintains desired fore-aft stability.

In general, the moveable dual drive axle system is a pivoted system carrying a free or powered oscillating pivot for the dual drive wheels. The pivot of the moveable drive axle system may be powered electronically, manually adjusted, and/or manually controlled. The pivoted system may carry independent suspensions for the individual drive wheels, dual axle beams having fixed wheel mountings, and/or a suspension for the drive axle system dependently.

In addition to the above, it is further a claim that the drive axle system suspension being dependent would utilize the adjustment controls as components of the suspension.

It is further a claim that features of the pivotally mounted dual drive axle system are applicable equally to dual tires mounting or track chassis mounting, and able to serve as the ground engaging component of the vehicle.

It is further a claim that the pivotally mounted drive axle system having independent suspension for each of its dual wheels may utilize an independent “A” arm type suspension mounted thereon to effectuate movement of the drive wheel thereon.

It is further a claim that the pivotally mounted drive axle system having independent suspension for each of its dual wheels may utilize a swing arm type suspension component integral with the assembly of the drive wheel thereon, or other suspension method in conjunction with oscillating beams of the dual drive wheel axle system.

It is further a claim that the pivotally mounted drive axle system having independent suspension for each of its dual wheels may utilize other suspension systems known by those knowledgeable in the art, such that suspension of the drive tires is effectuated within the pivotally mounted drive axle system.

It is further a claim that the electronic controller of the movable dual axle system may be a hydraulic cylinder, electric actuator, rotary actuator, electric linear motor, mechanical linkage, and manual method, as understood by those skilled in the art.

It is further a claim that control of the path and motion of the movable dual axle system may be accomplished by a variety o£ methods such as a pivoting system, a sliding system, a mechanical linkage system, and manual changes, as understood by those skilled in the art.

It is further a claim that the path of the moveable dual axle system may be configured to result in a significant upward or downward movement of the vehicle relative to the axle such that the vehicle body is possible to be held level fore-aft while going up or down slopes.

A controllable dual drive axle system of a vehicle whereby oscillating beams of the dual drive axle system are both free-oscillating and controllable oscillation. It is further a claim that the controllable oscillation is able to effectuate changes in tire traction, removal of a damaged tire from operation, removal from operation of the fore-positioned tires for reduction of drive and rolling effort of the vehicle, and ability to power oscillate the axle beams to effectuate lift of the front of the vehicle for the benefit of ease of zero-turn of the vehicle while balanced solely on the dual drive axle system. It is further a claim that the controller of the movable dual axle system's oscillating beams, either dependent or independent, may be a hydraulic cylinder(s), electric actuator(s), rotary actuator(s), electric linear motor(s), mechanical linkage(s), and manual method(s), as understood by those skilled in the art. With the vehicle having a controllable dual drive axle position system, the vehicle thereby has zero turn capability when utilizing the lift feature to lift the front end of the vehicle by power oscillation of the dual axle drive wheel beams, as understood by those skilled in the art, as a vehicle steered by independently varying the speed and direction of rotation of the drive wheels.

In general, a system for providing multiple axle drives utilizing controlled position of the multiple drive axles for maintaining vehicle balance and stability while maximizing traction capabilities of the vehicle is disclosed herein. An oscillating dual drive axle system and its associated suspension is moved so as to provide an improved fore-aft vehicle stability by achieving a movement of the center of gravity of the vehicle relative to the pivot of the oscillating dual drive axle. Control of the oscillation of the dual axle system further provides wheelbase stability options, reduction in drive wheels in use, and fore-aft tilting control of the vehicle balanced on a dual axle system. Advantages are realized with controlled movement o£ the axle system accounting for improved steering capabilities of a multiple axle drive vehicle, including zero-turn capabilities, controlled operation on slopes, sudden acceleration or braking, or for changes in vehicle loading and wheelbase and drive wheel configuration interests. Such a moveable oscillating dual axle system is seen to be applicable to vehicles of utility and/or mobility, such as turf care products, agricultural, construction, military, personal transportation, utility and delivery vehicles.

This concludes the detailed description of both the structures and operations of alternative embodiments of the vehicle 20 according to the present invention.

While the present invention has been described in what are presently considered to be its most practical and preferred embodiments and/or implementations, it is to be understood that the invention is not to be limited to the disclosed embodiments. On the contrary, the present invention is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A vehicle capable of traveling over uneven ground, said vehicle comprising:
an elongate frame having a front end, a rear end, and a fore-aft axis extending therebetween;
a body mounted to said frame;
a pair of front wheels rotatably mounted opposite each other with respect to said fore-aft axis at said front end of said frame;
an adjustable axle assembly mounted at said rear end of said frame such that said adjustable axle assembly is aligned substantially orthogonal to said fore-aft axis;
a first pair of rear wheels rotatably mounted opposite each other with respect to said fore-aft axis at the ends of said adjustable axle assembly;
a second pair of rear wheels rotatably mounted opposite each other with respect to said fore-aft axis at said ends of said adjustable axle assembly; and
an actuation system capable of mechanically moving said adjustable axle assembly to thereby adjust the fore-aft positions of said first and second pairs of rear wheels relative to said frame.

2. A vehicle according to claim 1, wherein said front wheels are non-steerable wheels selected from the group consisting of dolly wheels and caster wheels.

3. A vehicle according to claim 1, wherein said front wheels are steerable.

4. A vehicle according to claim 1, wherein said first and second pairs of rear wheels are drive wheels.

5. A vehicle according to claim 1, wherein said vehicle further comprises an electronic controller mounted to said body and electrically connected to said actuation system, and said electronic controller is capable of communicating electrical control signals to said actuation system to thereby adjust said fore-aft positions of said first and second pairs of rear wheels as necessary to actively help maintain the fore-aft balance and stability of said vehicle.

6. A vehicle according to claim 1, wherein said vehicle further comprises a supplemental actuation system capable of mechanically rotating said adjustable axle assembly to thereby adjust the heights of said first and second pairs of rear wheels relative to said frame.

7. A vehicle according to claim 6, wherein said vehicle further comprises an electronic controller mounted to said body and electrically connected to said supplemental actuation system, and said electronic controller is capable of communicating electrical control signals to said supplemental actuation system to thereby permit free and oscillatory rotation of said adjustable axle assembly as necessary to help maintain all said pair of front wheels, said first pair of rear wheels, and said second pair of rear wheels on said ground.

8. A vehicle according to claim 6, wherein said vehicle further comprises an electronic controller mounted to said body and electrically connected to said supplemental actuation system, and said electronic controller is capable of communicating electrical control signals to said supplemental actuation system to thereby adjust said heights of said first and second pairs of rear wheels as necessary to actively help maintain all said pair of front wheels, said first pair of rear wheels, and said second pair of rear wheels on said ground.

9. A vehicle according to claim 6, wherein said vehicle further comprises an electronic controller mounted to said body and electrically connected to said supplemental actuation system, and said electronic controller is capable of communicating electrical control signals to said supplemental actuation system to thereby adjust said heights of said first and second pairs of rear wheels as necessary to lift and actively help maintain one pair of wheels selected from the group consisting of said pair of front wheels, said first pair of rear wheels, and said second pair of rear wheels off said ground.

10. A vehicle according to claim 6, wherein said vehicle further comprises an electronic controller mounted to said body and electrically connected to said supplemental actuation system, and said electronic controller is capable of communicating electrical control signals to said supplemental actuation system to thereby adjust said heights of said first and second pairs of rear wheels as necessary to actively help maintain said body at a pre-selected pitch.

11. A vehicle capable of traveling over uneven ground with a load, said vehicle comprising:
an elongate frame having a front end, a rear end, and a fore-aft axis extending therebetween;
a body mounted to said frame;
a pair of front wheels rotatably mounted opposite each other with respect to said fore-aft axis at said front end of said frame;
an adjustable axle assembly mounted at said rear end of said frame such that said adjustable axle assembly is aligned substantially orthogonal to said fore-aft axis;
a first pair of rear wheels rotatably mounted opposite each other with respect to said fore-aft axis at the ends of said adjustable axle assembly;
a second pair of rear wheels rotatably mounted opposite each other with respect to said fore-aft axis at said ends of said adjustable axle assembly;
a first actuation system capable of mechanically moving said adjustable axle assembly to thereby adjust the fore-aft positions of said first and second pairs of rear wheels relative to said frame; and
a second actuation system capable of mechanically rotating said adjustable axle assembly to thereby adjust the heights of said first and second pairs of rear wheels relative to said frame.

12. A vehicle according to claim 11, wherein said front wheels are steerable.

13. A vehicle according to claim 11, wherein said first and second pairs of rear wheels are drive wheels.

14. A vehicle according to claim 11, wherein said vehicle further comprises an electronic controller mounted to said body and electrically connected to said first actuation system, and said electronic controller is capable of communicating electrical control signals to said first actuation system to thereby adjust said fore-aft positions of said first and second pairs of rear wheels as necessary to actively help maintain the fore-aft balance and stability of said vehicle.

15. A vehicle according to claim 11, wherein said vehicle further comprises an electronic controller mounted to said body and electrically connected to said second actuation system, and said electronic controller is capable of communicating electrical control signals to said second actuation system to thereby permit free and oscillatory rotation of said adjustable axle assembly as necessary to help maintain all said pair of front wheels, said first pair of rear wheels, and said second pair of rear wheels on said ground.

16. A vehicle according to claim 11, wherein said vehicle further comprises an electronic controller mounted to said body and electrically connected to said second actuation system, and said electronic controller is capable of communicating electrical control signals to said second actuation system to thereby adjust said heights of said first and second pairs of rear wheels as necessary to actively help maintain all said pair of front wheels, said first pair of rear wheels, and said second pair of rear wheels on said ground.

17. A vehicle according to claim 11, wherein said vehicle further comprises an electronic controller mounted to said body and electrically connected to said second actuation system, and said electronic controller is capable of communicating electrical control signals to said second actuation system to thereby adjust said heights of said first and second pairs of rear wheels as necessary to lift and actively help maintain one pair of wheels selected from the group consisting of said pair of front wheels, said first pair of rear wheels, and said second pair of rear wheels off said ground.

18. A vehicle capable of traveling over uneven ground, said vehicle comprising:
an elongate frame having a front end, a rear end, and a fore-aft axis extending therebetween;
a body mounted to said frame;
at least one ski mounted at said front end of said frame;
an adjustable axle assembly mounted at said rear end of said frame such that said adjustable axle assembly is aligned substantially orthogonal to said fore-aft axis;
a pair of drive track assemblies mounted opposite each other with respect to said fore-aft axis at the ends of said adjustable axle assembly;
a first actuation system capable of mechanically moving said adjustable axle assembly to thereby adjust the fore-aft position of said pair of drive track assemblies relative to said frame; and
a second actuation system capable of mechanically rotating said adjustable axle assembly to thereby adjust the pitch of said pair of drive track assemblies relative to said frame.

19. A vehicle according to claim 18, wherein said vehicle further comprises an electronic controller mounted to said body and electrically connected to said first actuation system, and said electronic controller is capable of communicating electrical control signals to said first actuation system to thereby adjust said fore-aft position of said pair of drive track assemblies as necessary to actively help maintain the fore-aft balance and stability of said vehicle.

20. A vehicle according to claim 18, wherein said vehicle further comprises an electronic controller mounted to said body and electrically connected to said second actuation system, and said electronic controller is capable of communicating electrical control signals to said second actuation system to thereby adjust said pitch of said pair of drive track assemblies as necessary to lift and actively help maintain said at least one ski off said ground.
